(19) United States
(12) Patent Application Publication
(10) Pub. No.: US 2014/0195165 A1
(43) Pub. Date: Jul. 10, 2014

(54) SYSTEMS AND METHODS FOR IDENTIFYING THE RELATIONSHIPS BETWEEN A PLURALITY OF GENES

(71) Applicant: THE TRANSLATIONAL GENOMICS RESEARCH INSTITUTE, Phoenix, AZ (US)

(72) Inventors: Seungchan Kim, Phoenix, AZ (US); Sungwon Jung, Phoenix, AZ (US)

(73) Assignee: THE TRANSLATIONAL GENOMICS RESEARCH INSTITUTE, Phoenix, AZ (US)

(21) Appl. No.: 14/078,994

(22) Filed: Nov. 13, 2013

Related U.S. Application Data
(60) Provisional application No. 61/726,399, filed on Nov. 14, 2012.

(51) Int. Cl. G06F 19/18

(52) U.S. Cl. CPC G06F 19/18
USPC 702/19

(57) ABSTRACT

The present invention relates to a method and system for the evaluation of differential dependencies of a set of discrete random variables between two conditions. In some embodiments, the system and method compares two conditions by evaluating the probability distributions of the likely dependency networks from random variables.

### CROSS-REFERENCE TO RELATED APPLICATIONS

The present application claims priority to U.S. Application No. 61/726,399, filed Nov. 14, 2012, the entire contents and disclosure of which are herein incorporated by reference.

### STATEMENT REGARDING FEDERALLY SPONSORED RESEARCH

This invention was made with government support under 29KS195 and 1U01CA168397-01, awarded by the National Cancer Institute and National Institutes of Health, respectively. The government has certain rights in the invention.

### FIELD OF THE INVENTION

This invention relates to systems and methods for evaluating the differentiality of a set of discrete random variables between two or more conditions, such as two different disease conditions. In particular embodiments, the systems and methods more specifically relate to comparisons of multiple conditions by evaluating the probability distributions of dependency networks from random variables and for identifying and evaluating the relationships between a plurality of genes.

### BACKGROUND OF THE INVENTION

Statistical approaches to identifying variables with differential patterns between different conditions can vary based on the definition of differentiality or the target feature of comparison. The simplest case of identifying differentiality is that of a single variable, where each variable in a target system is independently tested for differentiality. The main drawback of single variable test approaches is that these approaches focus on individual variables instead of a set of variables, while a set of interacting variables constitutes a functional module in many real-world applications. For this reason, a more beneficial approach is testing differentiality for a set of variables between conditions.

Several methods have been proposed to test the differentiality of a gene set between conditions by considering differential expressions of genes in the gene set. See, e.g., Subramanian, A. et al., “Gene set enrichment analysis: a knowledge-based approach for interpreting genome-wide expression profiles.” Proc Natl Acad Sci USA 102(43), 15545-50, 2005. See also, Ma, S. and Kosorok, M. R. “Identification of differential gene pathways with principal component analysis.” Bioinformatics 25(7), 882-889, 2009. See also, Shojaie, A. and Michailidis, G. “Analysis of gene sets based on the underlying regulatory network” Journal of Computational Biology 16(3), 407-426, 2009. These methods take a common approach of computing differential gene expression in the target gene set and summarizing the expression data into a single statistic that represents the differentiality of the gene set between conditions. These methods, however, are designed to capture only the gene sets with many genes that show consistent expression patterns under a target condition, although gene expression may differ under different conditions. Genes in biological pathways can maintain consistent interactions / relationships while providing various differing expression patterns. As such, the previous methods based on differential expressions have inherent limitations in identifying gene sets with differential genetic interactions / relationships.

As more evidence is found that biological systems can show highly diverse activity patterns, the concept of network-driven activities of biological functions has gained more interest. In particular, this interest is at least partially driven by the fact that genes can differentially interact across specific molecular contexts. An approach to evaluate such differential interactions is building separate networks for different conditions and comparing these data sets. See, Choi, J. K. et al. “Differential co-expression analysis using microarray data and its application to human cancer” Bioinformatics 21(24), 4348-4355, 2005. See also, Sharan, R. et al. “Conserved patterns of protein interaction in multiple species” Proceedings of the National Academy of Sciences of the United States of America 102(6), 1974-1979, 2005. See also Tischler, J. et al. “Evolutionary plasticity of genetic interaction networks” Nat Genet 40(4), 390-391, 2008. See also Gholami, A. M. and Fellenberg, K. “Cross-species common regulatory network inference without requirement for prior gene affiliation” Bioinformatics 26(8), 1082-1090, 2010.

With the need for more statistical power to discriminate differential interactions, several studies proposed statistical methods to test the differentiality of individual interactions. See, Lai, Y. et al. “A statistical method for identifying differential gene-gene co-expression patterns” Bioinformatics 20(17), 3146-3155, 2004. See also, Hu, R. et al. “Detecting inter-gene correlation changes in microarray analysis: a new approach to gene selection” BMC Bioinformatics 10(1), 20, 2009. See also, Mentzen, W. et al. “Dissecting the dynamics of dysregulation of cellular processes in mouse mammary gland tumor” BMC Genomics 10(1), 601, 2009. See also, Leonardson, A. S. et al. “The effect of food intake on gene expression in human peripheral blood” Human Molecular Genetics 19(1), 159-169. Besides these methods for individual differential interactions, there have been recent studies to identify differential sub-networks across conditions. See Guo, Z. et al. “Edge-based scoring and searching method for identifying condition-responsive protein-protein interaction sub-network” Bioinformatics 23(16), 2121-2128, 2007. See also, Hwang, T. and Park, T. “Identification of differentially expressed subnetworks based on multivariate ANOVA” BMC Bioinformatics 10(1), 128, 2009. See also, Kim, Y. et al. “Principal network analysis: Identification of subnetworks representing major dynamics using gene expression data” Bioinformatics, 2010. See also, Ma, H. et al. “COSINE: Condition-specific sub-network identification using a global optimization method” Bioinformatics, 2011.

The general idea of such an approach is utilizing already known genetic interactions as a ground truth network and overlaying observed genomic data. In addition to these methods using already known interactions, a few methods have been proposed that operate without using known interactions. See Zhang, B. et al. “Differential dependency network analysis to identify condition-specific topological changes in biological networks” Bioinformatics 25(4), 526-532, 2009. See also, Zhang, B. et al. “DDN: a caBIG® analytical tool for differential network analysis” Bioinformatics 27(7), 1036-1038, 2011. See also, Ouyang, Z. et al. “Conserved and differential gene interactions in dynamical biological systems” Bioinformatics, 2011. All of these methods were designed to identify individual differential interactions or condition-specific sub-networks, but these approaches were not designed to test gene sets for dependency variance across conditions. In addition, Choi and Kendziorski proposed Gene Set Co-Expression Analysis (GSCA), which computes Euclidean distance between gene interaction correlation vectors from two different conditions as a discrepancy measure. Choi, Y. and C. Kendziorski “Statistical methods for gene set co-expression analysis” Bioinformatics 25(21): 2780-2786, 2009. GSCA was designed to test gene sets for interaction differentiality, but it can be too sensitive to minor correlation changes and may provide biased results with respect to the size of gene sets.

Since the emergence of high-throughput genomic profiling techniques, numerous statistical methods gained popularity in biomedical studies to assess diverse features in biological samples. One conventional statistical approach encompasses identifying variables with differential patterns between different conditions, where biological molecules (e.g., nucleic acids, peptides, polypeptides, or proteins) are often modeled as target variables. Such conventional methods can vary based on the definition of differentiality or the identity of the target feature of comparison, but the general idea is comparing probability distributions of a target feature across given conditions.

Generally, the simplest case of identifying differentiality is that of a single variable, where each variable in a target system is independently tested for differentiality. There have been many studies that use this approach of independent tests for individual variables. The main drawback of single variable test approaches is the focus on individual variables instead of a set of variables because a set of interacting variables constitutes a functional module in many real world applications. For this reason, a more beneficial approach is testing the differentiality of a set of variables between conditions.

Considering that a joint probability distribution of a set of variables can provide a complete picture of the pattern, an improved method to test differentiality of a set of variables between conditions is comparing the joint probability distributions. This approach, however, is not practical in many real situations due to the complexity of the model to represent the joint probability distribution, and the lack of available data to infer such complex models with sufficient reliability. For this reason, most of the methods to test the differentiality of a set of variables rely on heuristic approaches that focus on specific features in the set of variables rather than considering the complete joint probability distributions.

Some systems comprise methods to test the differentiality of a gene set between conditions by considering differential gene expression within the gene set. These methods can employ a common approach of computing differential gene expression in the target gene set and summarizing the results into a single statistic that represents the differentiality of the gene set between conditions. Gene Set Enrichment Analysis (GSEA), for example, is a popular method of testing gene sets, where the system computes the degree to which the expression of a gene set is specifically correlated to a target condition. GSEA has been successfully applied in recent studies, but it is designed to capture only the gene sets with overall over- or under-expression in a target condition. Genes in biological pathways do not necessarily always show differential expression in the same direction. As such, there is a need for methods to evaluate relationships between genes in computing the differentiality statistics.

### SUMMARY OF THE INVENTION

Some embodiments of the invention provide a computer-implemented method of statistical testing for identifying or evaluating relationships between a plurality of genes. In one embodiment, the method comprises receiving a target gene set containing a plurality of genes across a plurality of conditions and evaluating each gene in the target gene set as a discrete random variable. The method further comprises identifying a plurality of likely dependency network structures for the plurality of genes for each condition and computing a probability distribution of the likely dependency network structures for each condition. The method further includes computing overall differential dependency relationships between genes in a target gene set across the plurality of conditions by calculating a difference between each probability distribution of likely dependency network structures among the plurality of conditions. The method may also include identifying a plurality of biological functions and pathways that show genetic relationships across the plurality of conditions using the overall differential dependency relationships.

Some embodiments of the invention may also include computing the probability distribution of the likely dependency network structures by computing a posterior probability for each of the dependency network structures. For example, computing the probability distribution of the likely dependency network structures comprises computing

$$Pr ( {g}_{i} \vert {D}_{C} ) = \frac{Pr ( {D}_{C} \vert {g}_{i} )}{{\sum }_{k = 1}^{N} Pr ( {D}_{C} \vert {g}_{k} )}$$

wherein Pr(D_{C}|gᵢ) is a likelihood, g is a dependency network, D_{C} is an observed condition, and i is greater than or equal to 1. Moreover, computing the posterior probability for each of the likely dependency network structures may also include using a Bayesian Dirichlet equivalence uniform (BDeu) scoring method.

In some aspects, computing a probability distribution of the likely dependency network structures proposing comprises computing:

Prₚᵣₒₚₒₛₑ(i;j|D_{C})=(1−pᵢⱼ)^{λ},

for a probable dependency structure, gₖ, that is proposed for D_{C}, wherein: λ≧1; eᵢⱼ and eⱼᵢ are edges between variables Vᵢ and Vⱼ; a direction of at least one of eᵢⱼ and eⱼᵢ is randomly chosen with a probability of 0.5 when the random choice complies with an acyclic property of a directed acrylic graph (DAG) for gₖ; each of a dependency between Vᵢ and Vⱼ is independently evaluated; and a χ2-test is applied to test the independency between each pair of Vᵢ and Vⱼ to obtain a p-value wherein (pᵢⱼ) (=pⱼᵢ). In addition, the method may further comprise computing the overall differential dependency relationships between genes in a target gene set across the plurality of conditions, which may include computing a divergence between conditions among the plurality of conditions and computing a statistical significance of a condition among the plurality of conditions. In particular, computing the divergence between conditions further comprises measuring the divergence using a Jensen-Shannon (JS) divergence and computing the statistical significance of a condition further comprises computing the statistical significance with a permutation approach.

Some embodiments of the invention provide a system comprising: a processor; and a non-transitory computer-readable storage medium storing instructions which, when executed on the processor, perform a method. In some aspects, the method includes receiving a target gene set containing a plurality of genes across a plurality of conditions, evaluating each gene as a discrete random variable, identifying a plurality of likely dependency network structures for the plurality of genes for each condition, computing a probability distribution of the likely dependency network structures for each condition, computing overall differential dependency relationships between genes in a target gene set across the plurality of conditions by calculating a difference between each probability distribution of the likely dependency network structures among the plurality of conditions, and identifying a plurality of biological functions and pathways that show genetic relationships across the conditions using the overall differential dependency relationships.

Some embodiments of the invention provide a method of statistical testing for identifying or evaluating relationships between a plurality of genes, with the method comprising obtaining a target gene set containing a plurality of genes across a plurality of conditions and evaluating each gene as a discrete random variable. In some aspects of the invention, the method also includes identifying a plurality of likely dependency network structures for the plurality of genes for each condition, determining a probability distribution of the likely dependency network structures for each condition, determining an overall differential dependency relationships between genes in a target gene set across the plurality of conditions by calculating a difference between each probability distribution of the likely dependency network structures among the plurality of conditions, and identifying a plurality of biological functions and pathways that show genetic relationships across the plurality of conditions using the overall differential dependency relationships.

Some embodiments of the invention include determining the probability distribution of the likely dependency network structures, which can comprise computing a posterior probability for each of the likely dependency network structures. For example, determining the probability distribution of the likely dependency network structures further comprises computing

$$Pr ( {g}_{i} \vert {D}_{C} ) = \frac{Pr ( {D}_{C} \vert {g}_{i} )}{{\sum }_{k = 1}^{N} Pr ( {D}_{C} \vert {g}_{k} )}$$

wherein Pr(gᵢ|D_{C}) is a likelihood, g is a dependency network, i is greater than 1, D_{C} is an observed condition. In some aspects, determining the posterior probability for each of the likely dependency network structures further comprises using a Bayesian Dirichlet equivalence uniform (BDeu) scoring method. Moreover, determining a probability distribution of the likely dependency network structures comprises computing:

Prₚᵣₒₚₐₙₑ(i; j|D_{C})=(1−pᵢⱼ)^{λ},

for a probable dependency structure, gₖ, that is proposed for D_{C}, when λ≧1, eᵢⱼ and eⱼᵢ are edges between variables Vᵢ and Vⱼ, a direction of at least one of eᵢⱼ and eⱼᵢ is randomly chosen with a probability of 0.5 when the random choice complies with an acyclic property of a directed acrylic graph (DAG) for gₖ, each of a dependency between Vᵢ and Vⱼ is independently evaluated, and a χ2-test is applied to test the independency between each pair of Vᵢ and Vⱼ to obtain a p-value wherein (pᵢⱼ) (=pⱼᵢ).

Additional objectives, advantages and novel features will be set forth in the description which follows or will become apparent to those skilled in the art upon examination of the drawings and detailed description which follows.

### REFERENCE TO COLOR FIGURES

This application contains at least one photograph executed in color. Copies of this patent application publication with color photographs will be provided by the Office upon request and payment of the necessary fee.

### BRIEF DESCRIPTION OF THE DRAWINGS

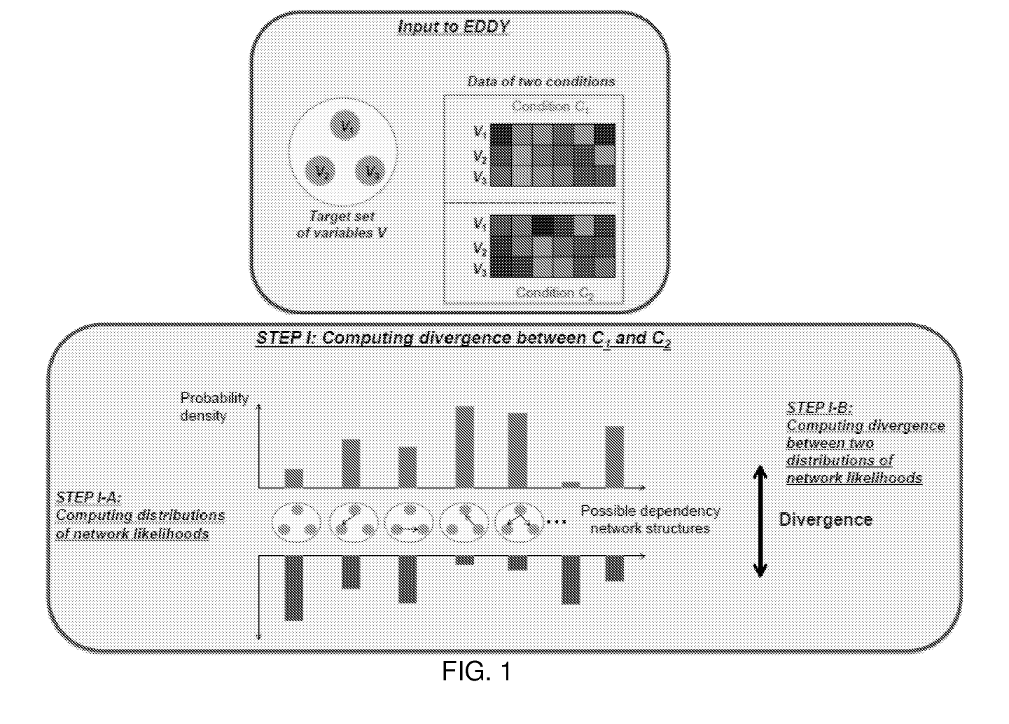

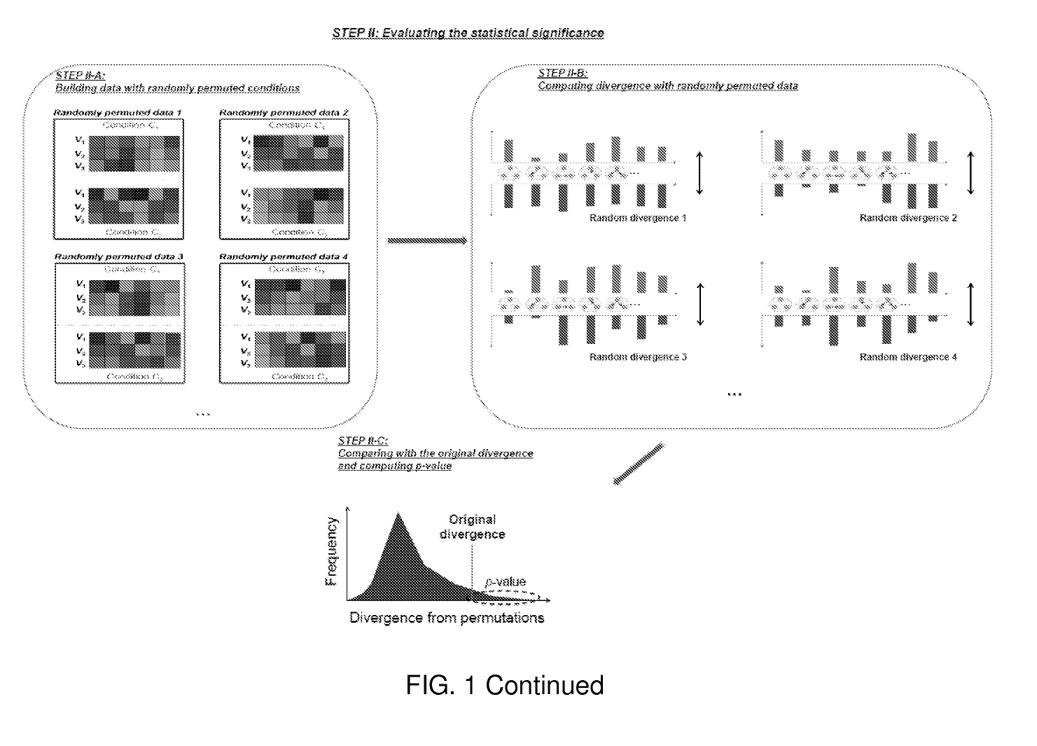

FIG. 1 depicts the computation of the divergence between two probability distributions of dependency network structures from the given data sets of two different conditions, and the evaluation of its statistical significance through a permutation test.

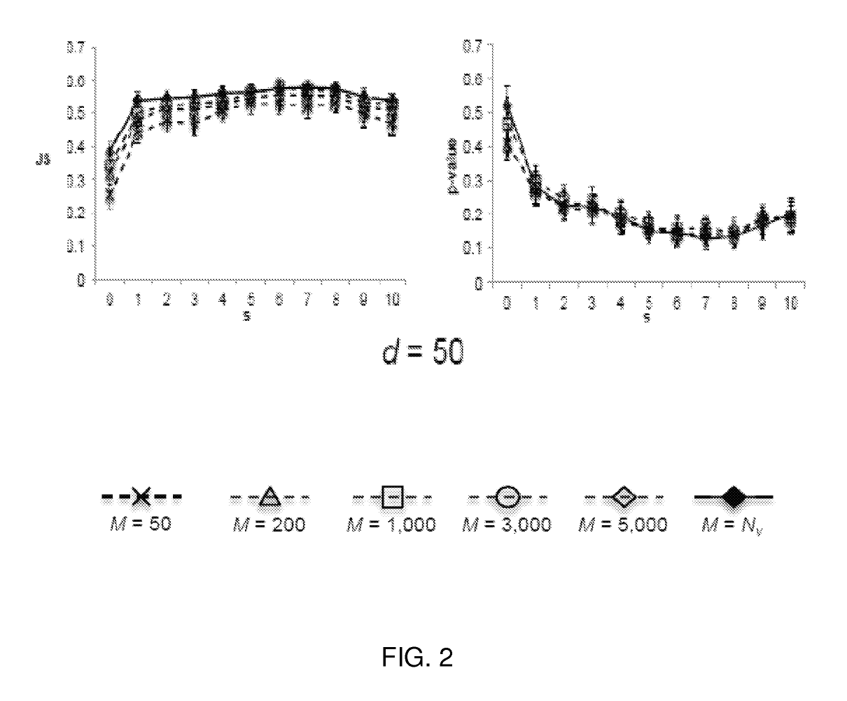

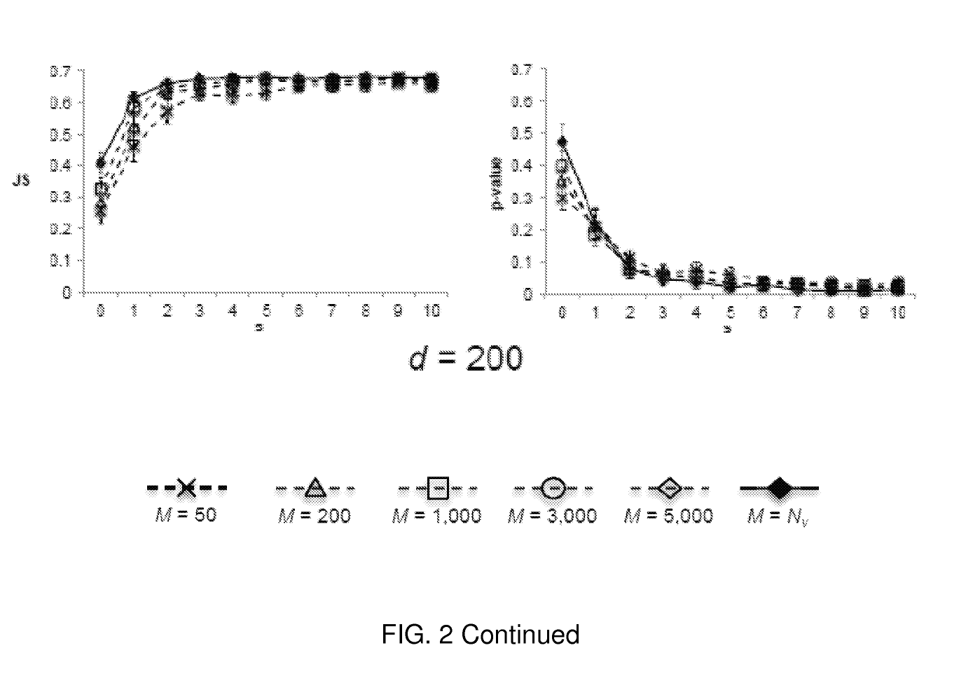

FIG. 2 shows a series of graphs displaying JS divergence (left side) and p-values (right side) from applying EDDY to compare D₀ and Dₛ, where v=5 variables. K=v−1 was used for the execution of EDDY. Each point in the plots represents the average from 100 repetitions. The error bars indicate 95% confidence interval of the average.

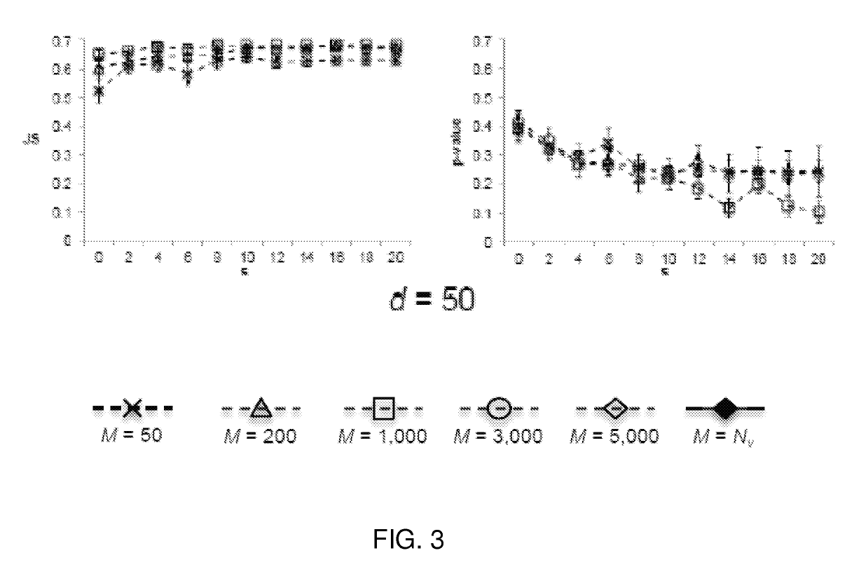

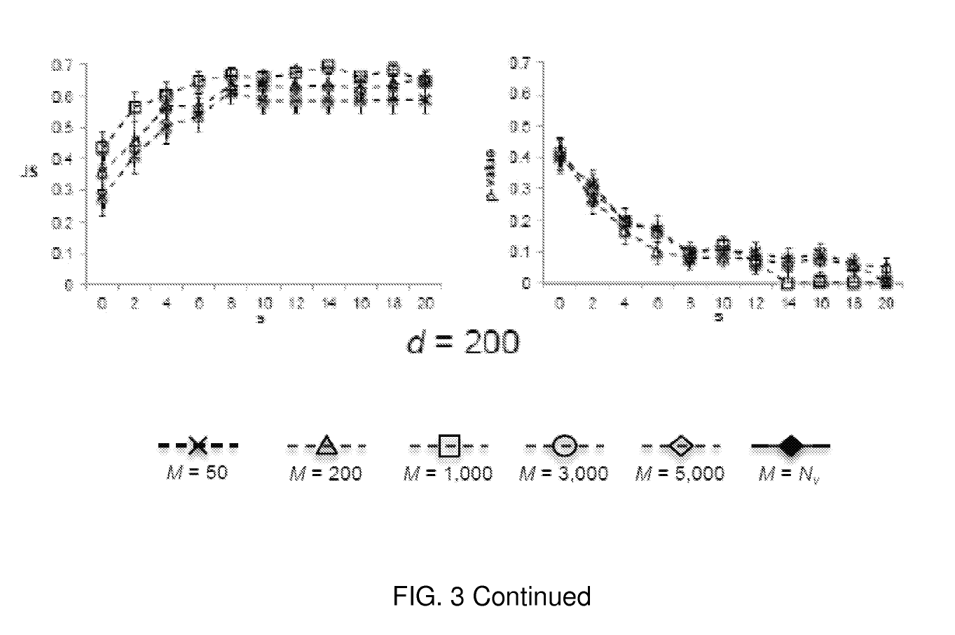

FIG. 3 shows a series of graphs displaying JS divergence (left side) and p-values (right side) from applying EDDY to compare D₀ and Dₛ, where v=10 variables. K=v−1 was used for the execution of EDDY. Each point in the plots represents the average from 100 repetitions. The error bars indicate 95% confidence interval of the average.

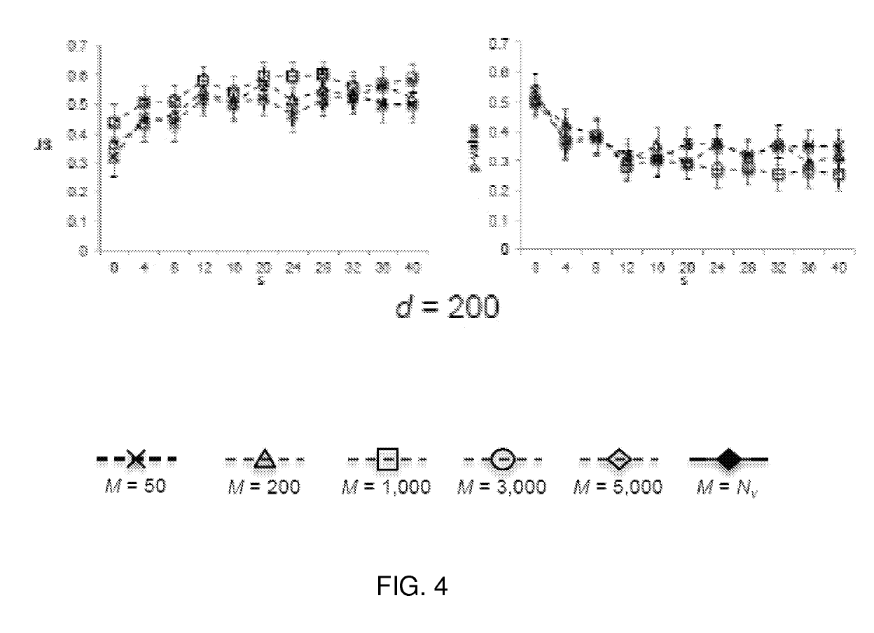

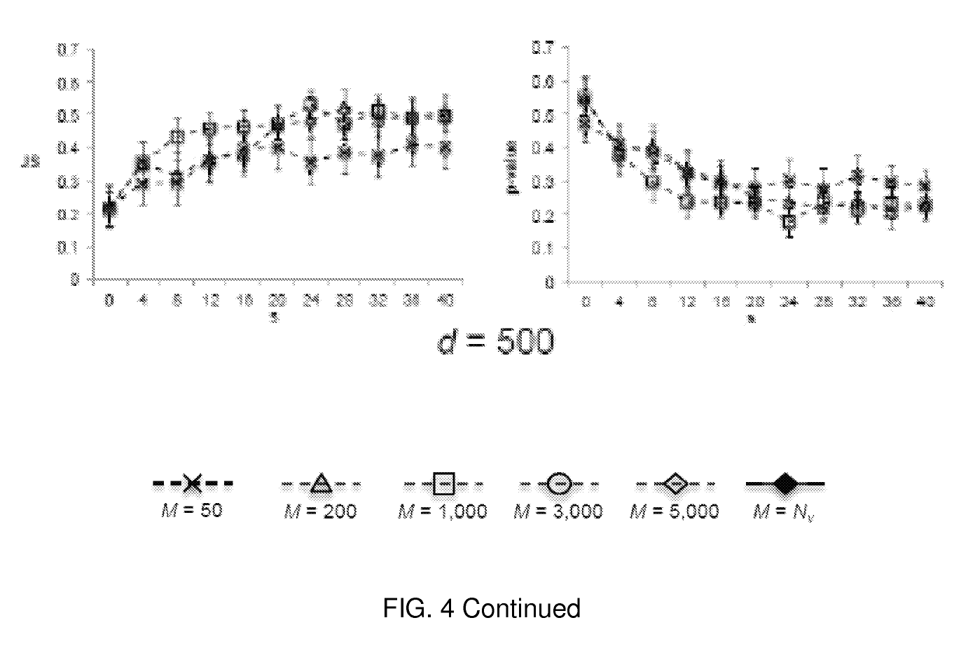

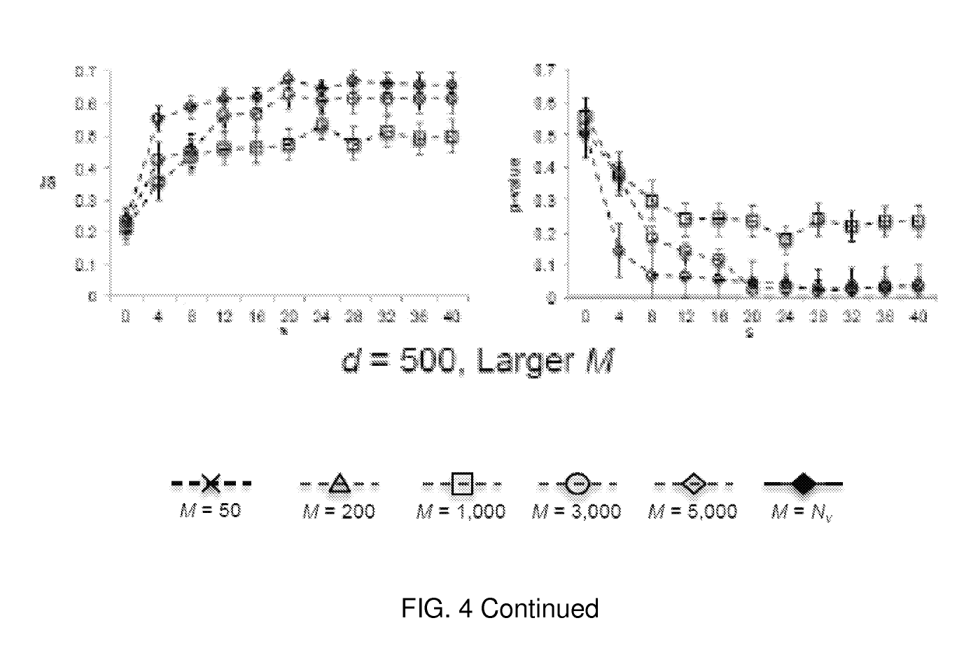

FIG. 4 shows a series of graphs displaying JS divergence (left side) and p-values (right side) from applying EDDY to compare D₀ and Dₛ, where v=20 variables. K=v−1 was used for the execution of EDDY. Each point in the plots represents the average from 100 repetitions. The error bars indicate 95% confidence interval of the average.

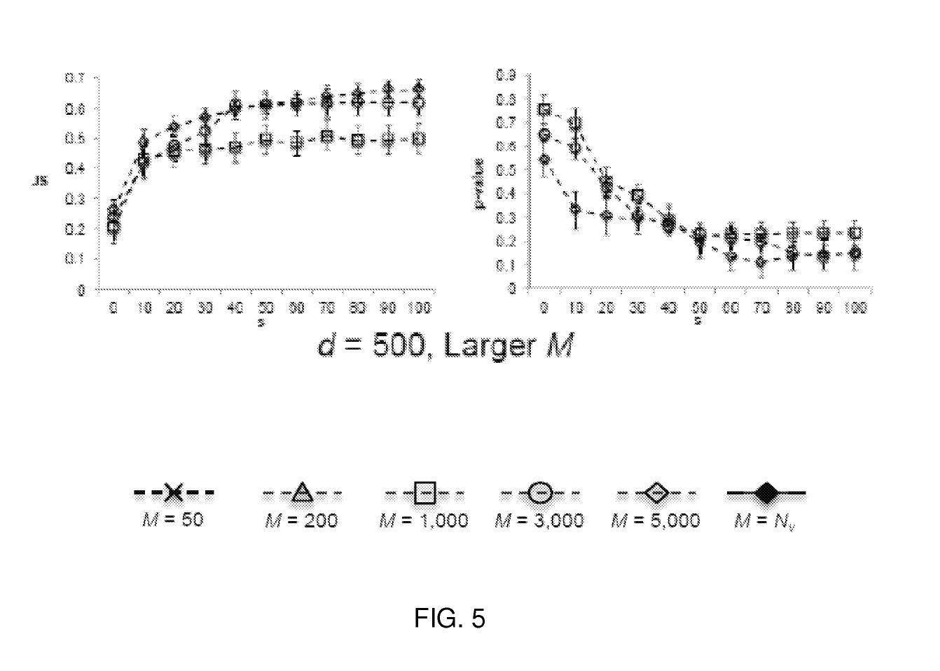

FIG. 5 shows a series of graphs displaying JS divergence (left side) and p-values (right side) from applying EDDY to compare D₀ and Dₛ, where v=50 variables. K=v−1 was used for the execution of EDDY. Each point in the plots represents the average from 100 repetitions. The error bars indicate 95% confidence interval of the average.

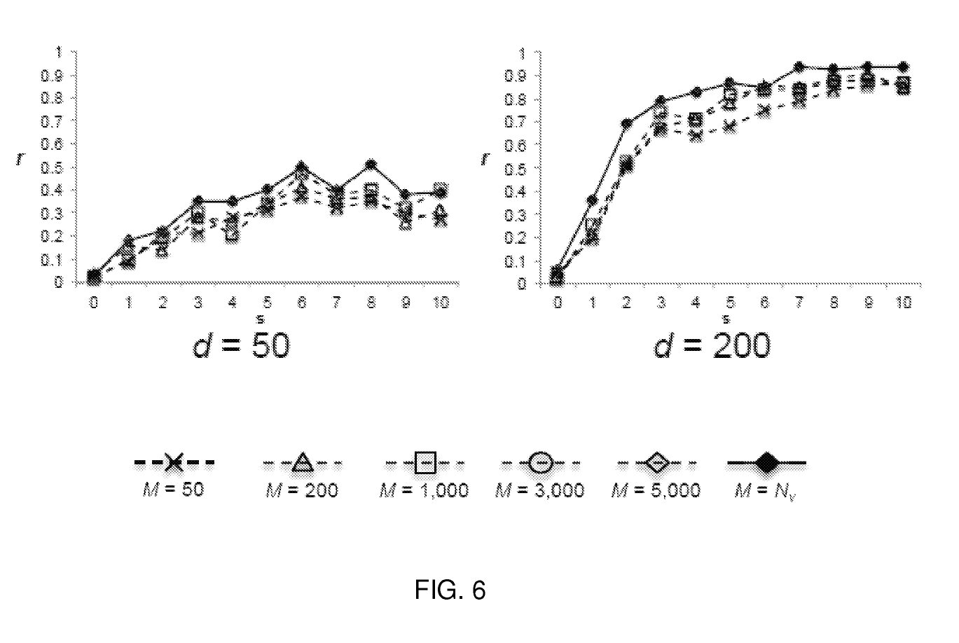

FIG. 6 shows two graphs that display the ratio of statistically significant cases with p-value <0.05 out of 100 repetitions of applying EDDY to compare D₀ and Dₛ, where v=5 variables. K=v−1 was used for the execution of EDDY. Note that the cases of s=0 correspond to false positives as both D₀ and Dₛ are derived from the same network, and those of s>0 correspond to true positives.

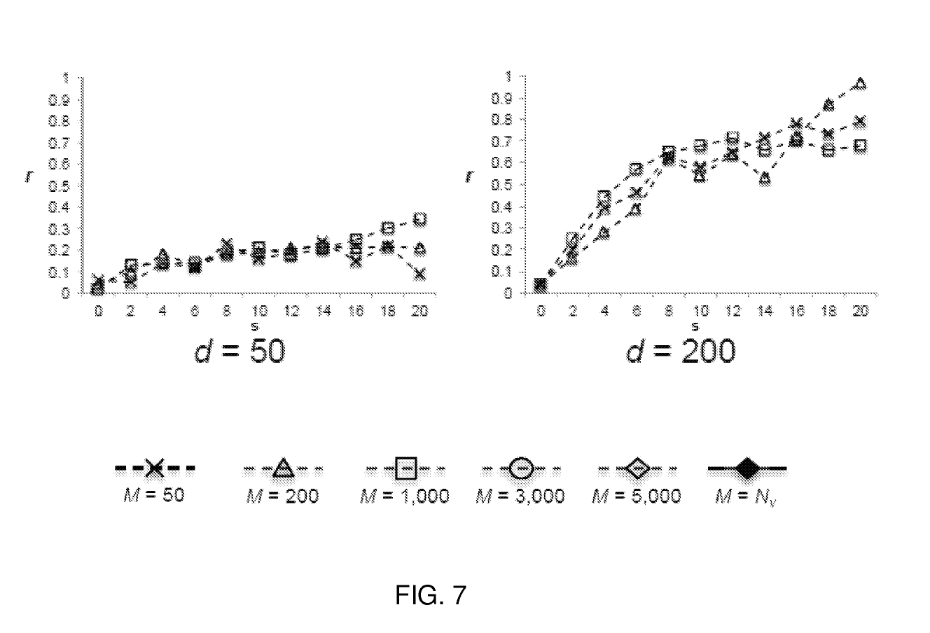

FIG. 7 shows two graphs that display the ratio of statistically significant cases with p-value <0.05 out of 100 repetitions of applying EDDY to compare D₀ and Dₛ, where v=10 variables. K=v−1 was used for the execution of EDDY. Note that the cases of s=0 correspond to false positives as both D₀ and Dₛ are derived from the same network, and those of s>0 correspond to true positives.

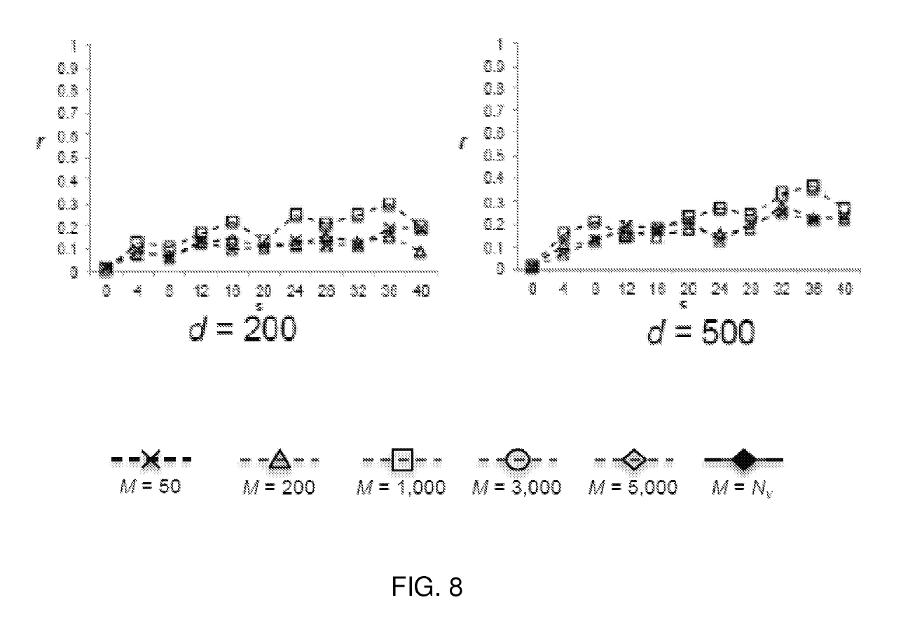

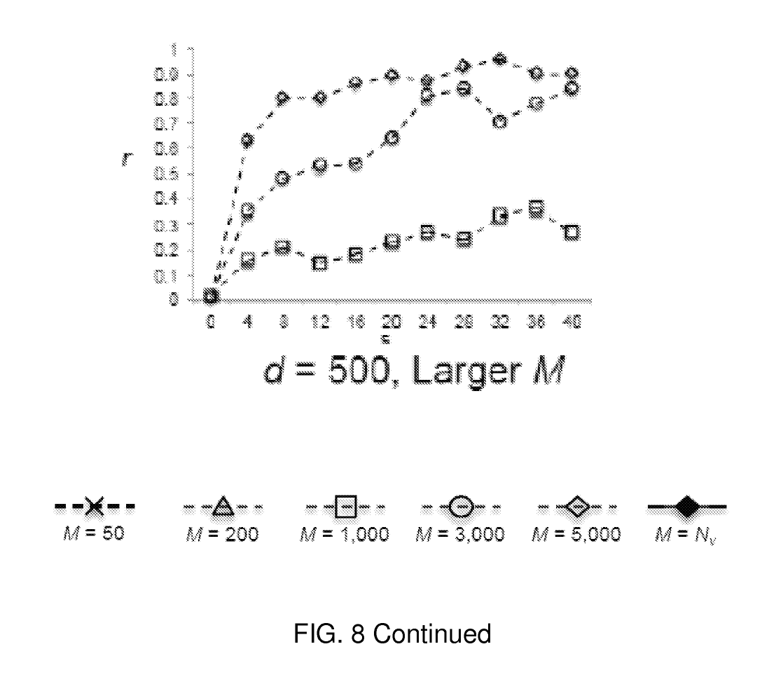

FIG. 8 shows three graphs that display the ratio of statistically significant cases with p-value <0.05 out of 100 repetitions of applying EDDY to compare D₀ and Dₛ, where v=20 variables. K=v−1 was used for the execution of EDDY. Note that the cases of s=0 correspond to false positives as both D₀ and Dₛ are derived from the same network, and those of s>0 correspond to true positives.

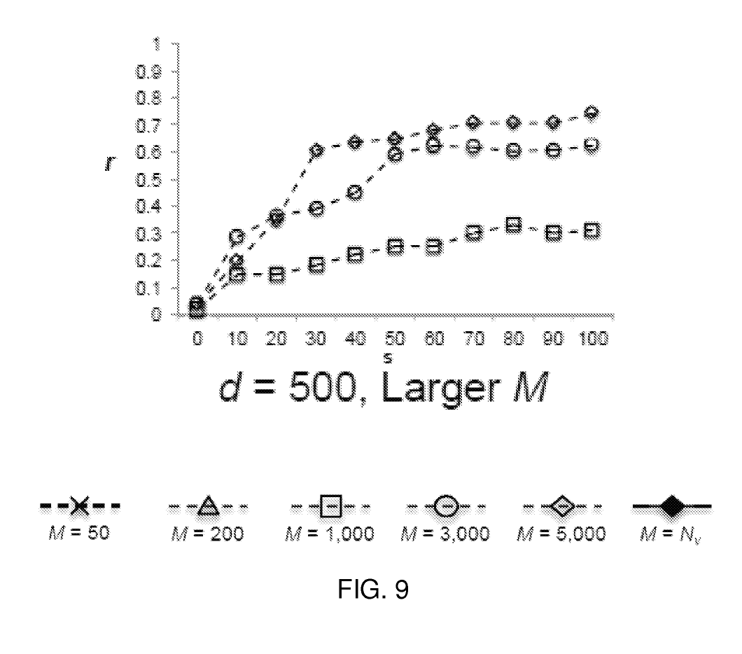

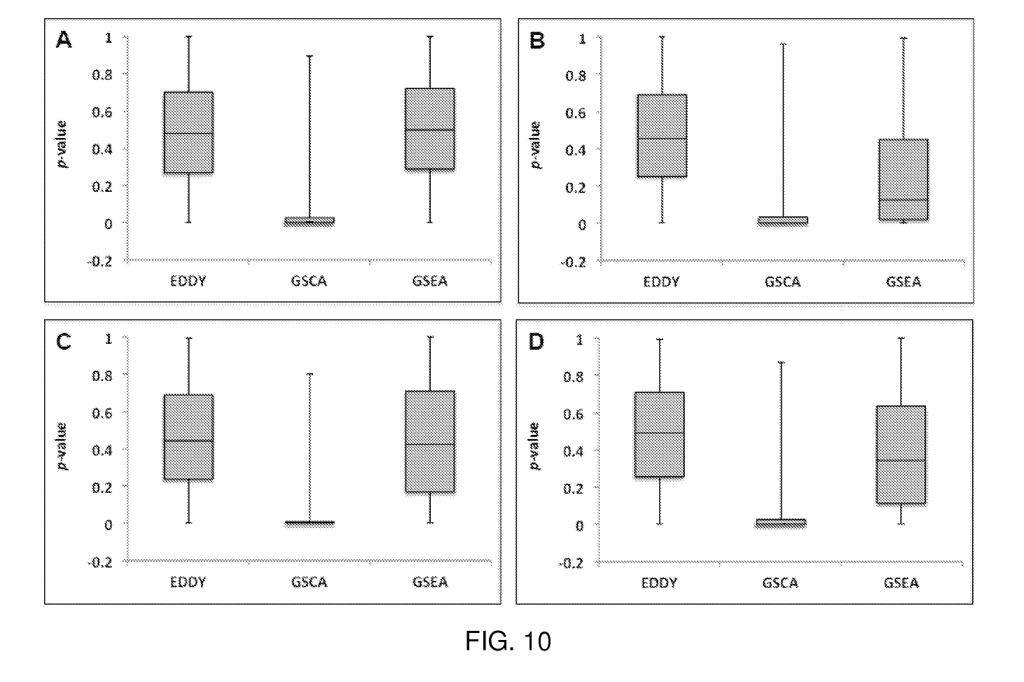

FIG. 9 shows a graph that displays the ratio of statistically significant cases with p-value <0.05 out of 100 repetitions of applying EDDY to compare D₀ and Dₛ, where v=50 variables. K=v−1 was used for the execution of EDDY. Note that the cases of s=0 correspond to false positives as both D₀ and Dₛ are derived from the same network, and those of s>0 correspond to true positives.

FIG. 10 shows a series of boxplots of p-values from applying three different gene set test methods (EDDY, GSEA, and GSCA) to each subtype of TOGA GBM gene expression data. Each box represents upper and lower quartiles of p-values along with the median. Ends of whiskers represent minimum and maximum p-values. FIG. 10A represents data from testing the Classical subtype of GBM versus all non-Classical subtypes of GBM. FIG. 10B represents data from testing the Mesenchymal subtype of GBM versus all non-Mesenchymal subtypes of GBM. FIG. 10C represents data from testing the Neural subtype of GBM versus all non-Neural subtypes of GBM. FIG. 10D represents data from testing the Proneural subtype of GBM versus all non-Proneural subtypes of GBM.

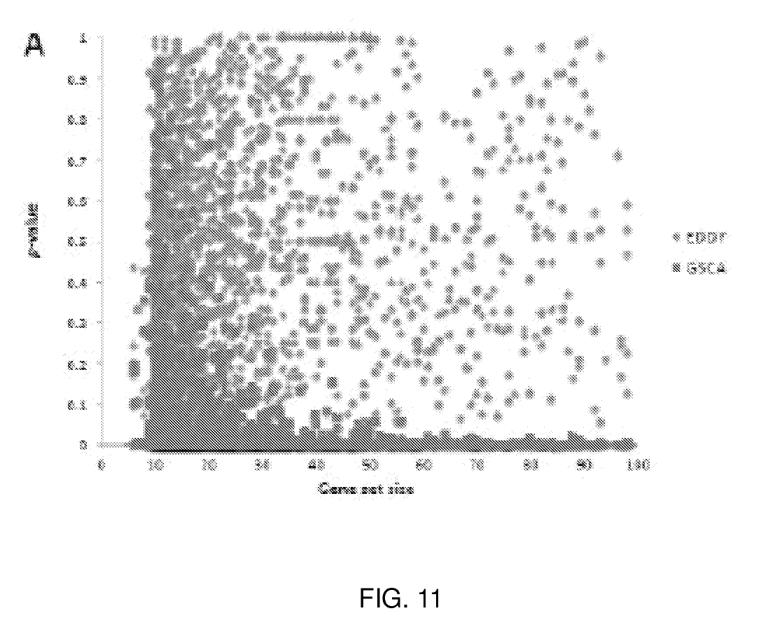

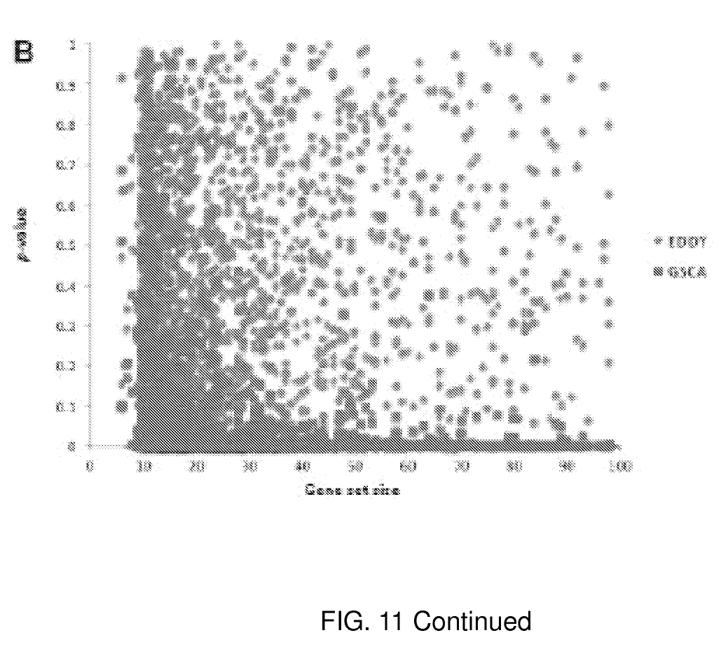

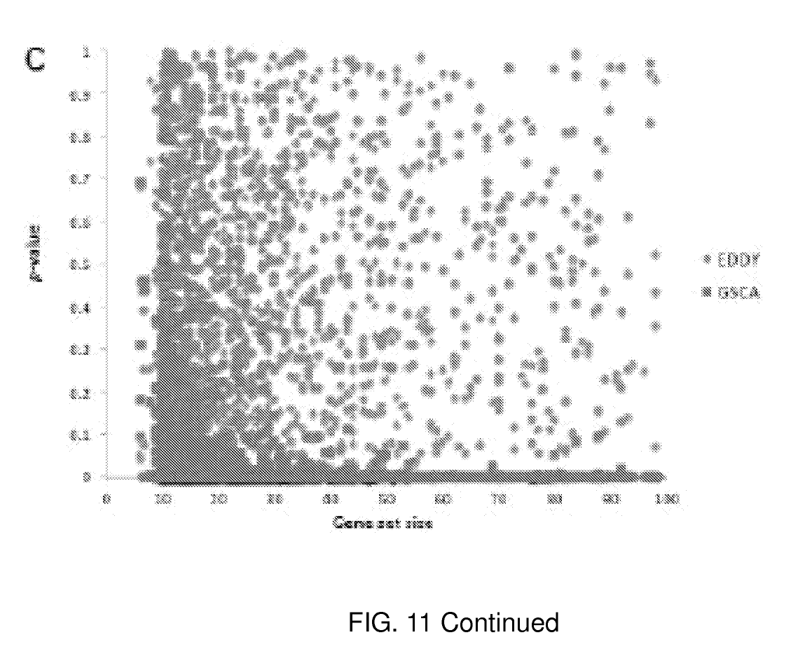

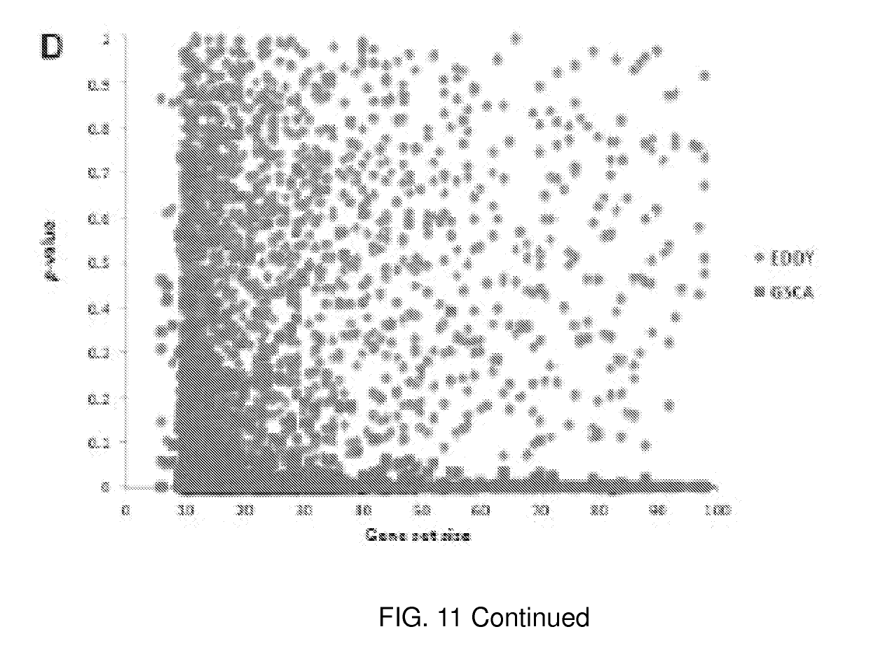

FIG. 11 is a series of scatterplots of p-values versus the size of gene sets that were obtained after applying EDDY and GSCA to each subtype of TOGA GBM gene expression data. Each dot represents a gene set, which is positioned based on its size (number of genes) and p-value from testing. Lighter-colored dots represent gene set p-values from EDDY and darker-colored dots represent gene set p-values from GSCA. Gene sets with more than 100 genes were omitted for better visibility. FIG. 11A represents data from testing the Classical subtype of GBM versus all non-Classical subtypes of GBM. FIG. 11B represents data from testing the Mesenchymal subtype of GBM versus all non-Mesenchymal subtypes of GBM. FIG. 11C represents data from testing the Neural subtype of GBM versus all non-Neural subtypes of GBM. FIG. 11D represents data from testing the Proneural subtype of GBM versus all non-Proneural subtypes of GBM.

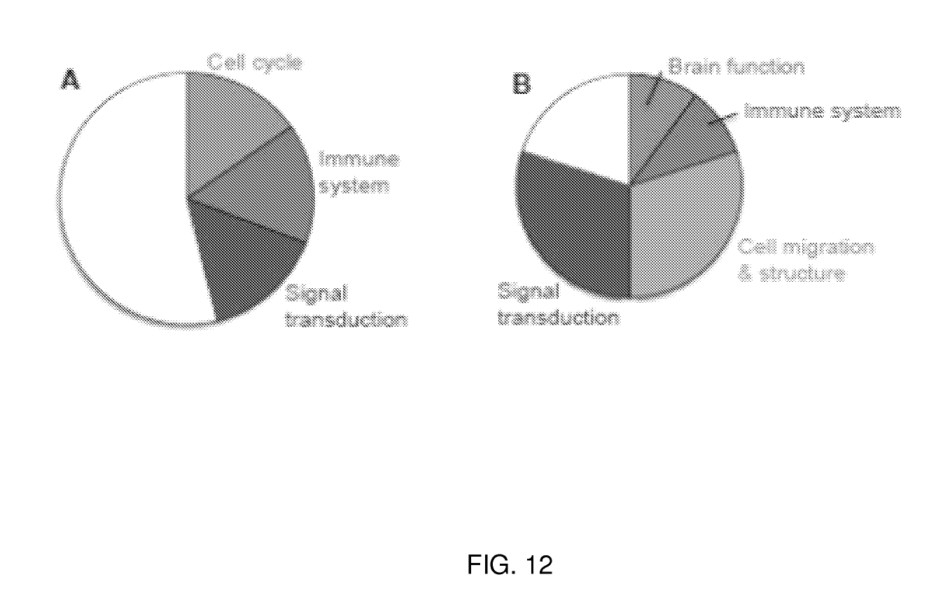

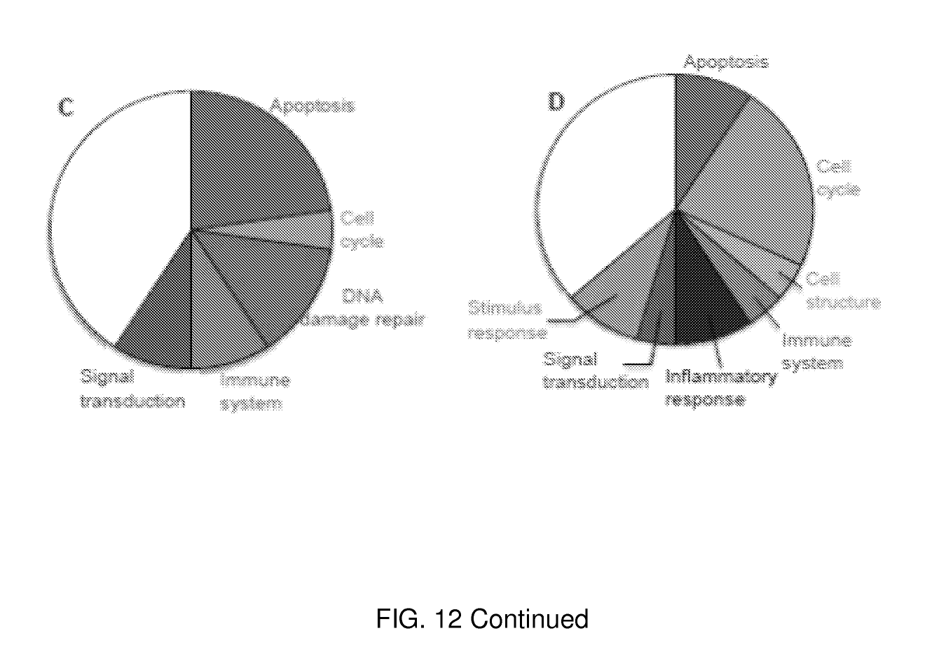

FIG. 12 shows a chart displaying the relative amount of statistically significant gene sets identified, based on their relevant functions, for (FIG. 12A) Classical, (FIG. 12B) Mesenchymal, (FIG. 12C) Neural, and (FIG. 12D) Proneural.

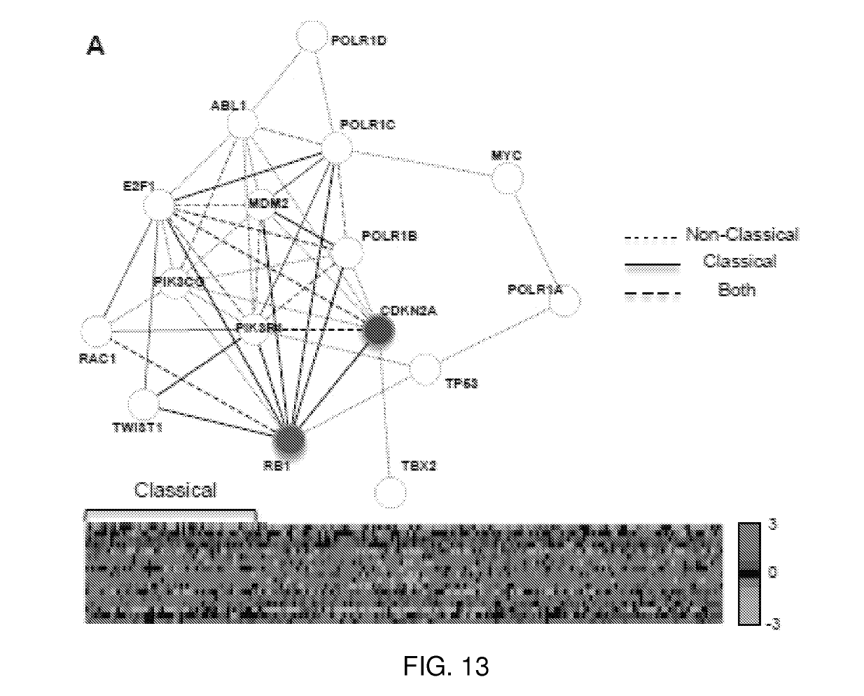

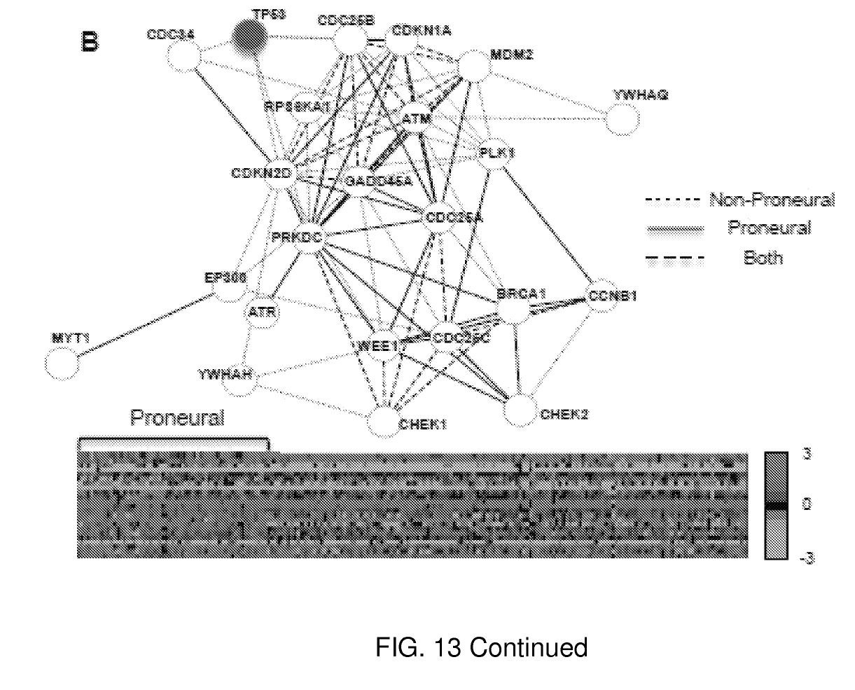

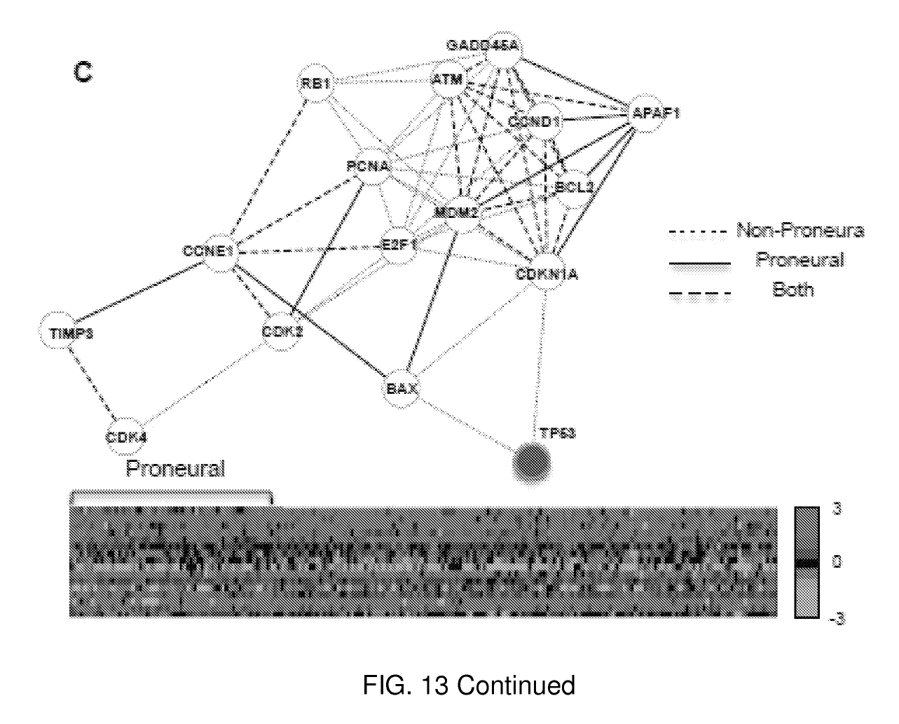

FIG. 13 depicts selected pathway gene sets identified using EDDY. Each network diagram is a visualization of representative dependency relationships in each pathway. Dependency relationships only in each subtype samples are represented with solid edges. Dependency relationships observed for both subtype and non-subtype samples were denoted with dashed edges. Each heat map shows the standardized expressions for the corresponding pathway genes. FIG. 13A represents data related to the ARF pathway gene set from an analysis of the Classical subtype of GBM versus all non-Classical subtypes of GBM. FIG. 13B represents data related to the G2 pathway gene set from an analysis of the Proneural subtype of GBM versus all non-Proneural subtypes of GBM. FIG. 13C represents data related to the p53 pathway gene set from an analysis of the Proneural subtype of GBM versus all non-Proneural subtypes of GBM.

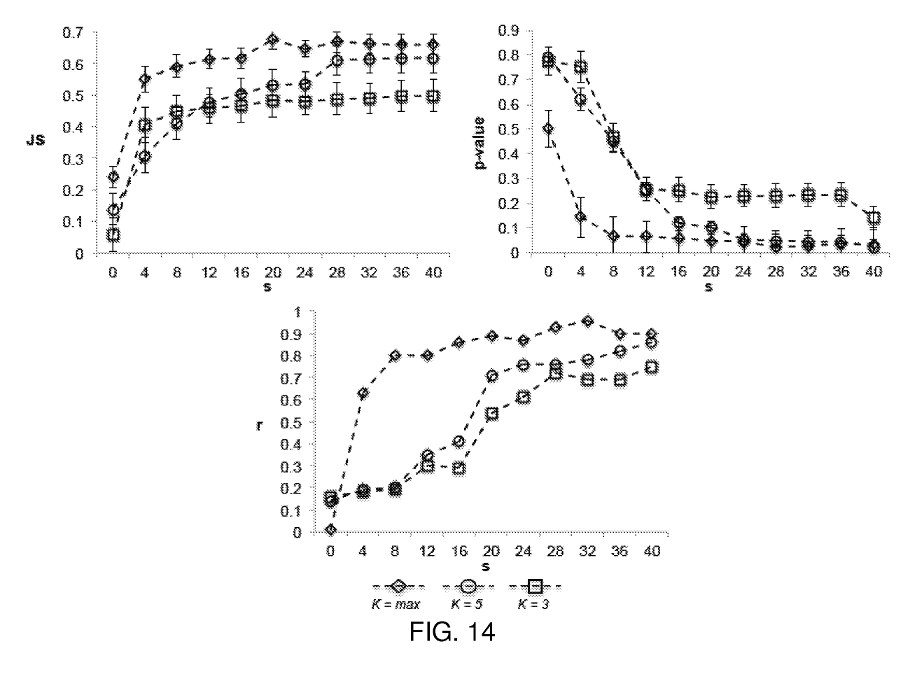

FIG. 14 is a series of graphs depicting JS values, p-values, and the ratio of statistically significant cases with p-value <0.05 out of 100 repetitions of applying EDDY to compare D₀ and Dₛ for 20 variables. Five hundred samples were generated for each condition.

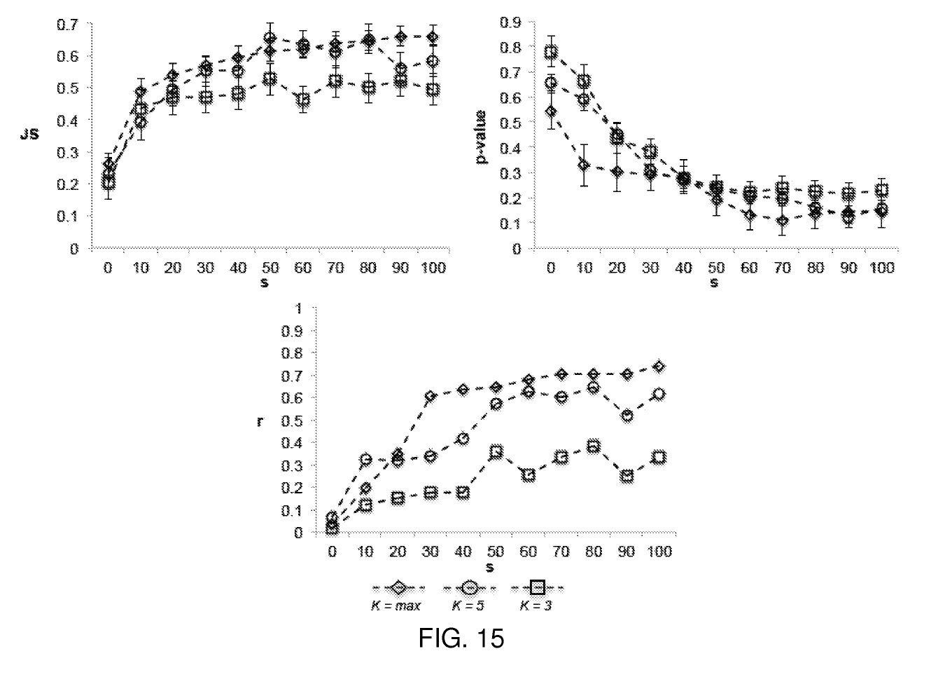

FIG. 15 is a series of graphs depicting JS values, p-values, and the ratio of statistically significant cases with p-value <0.05 out of 100 repetitions of applying EDDY to compare D₀ and Dₛ for 50 variables. Five hundred samples were generated for each condition.

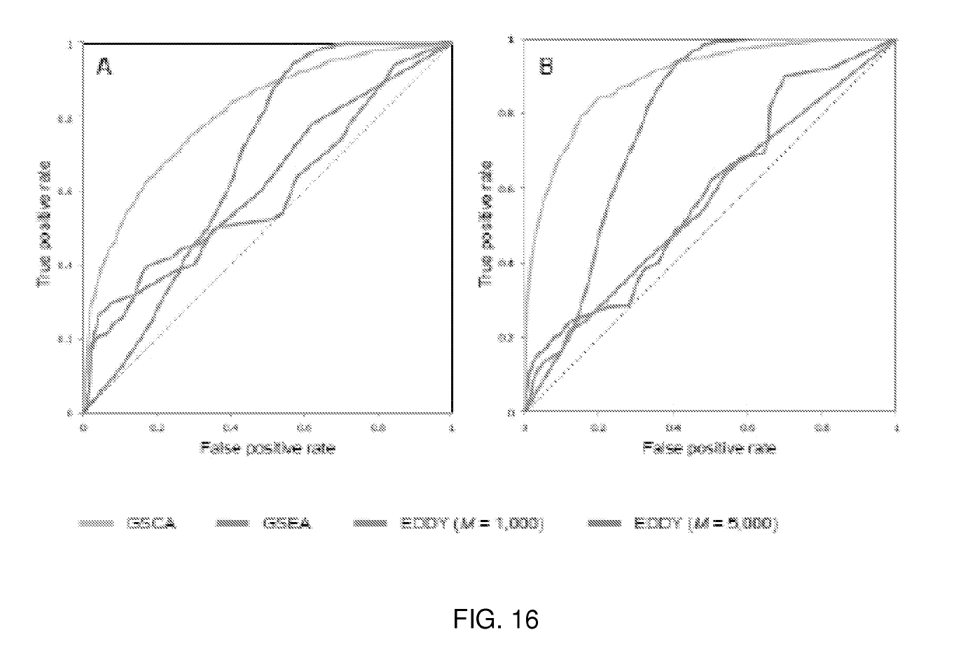

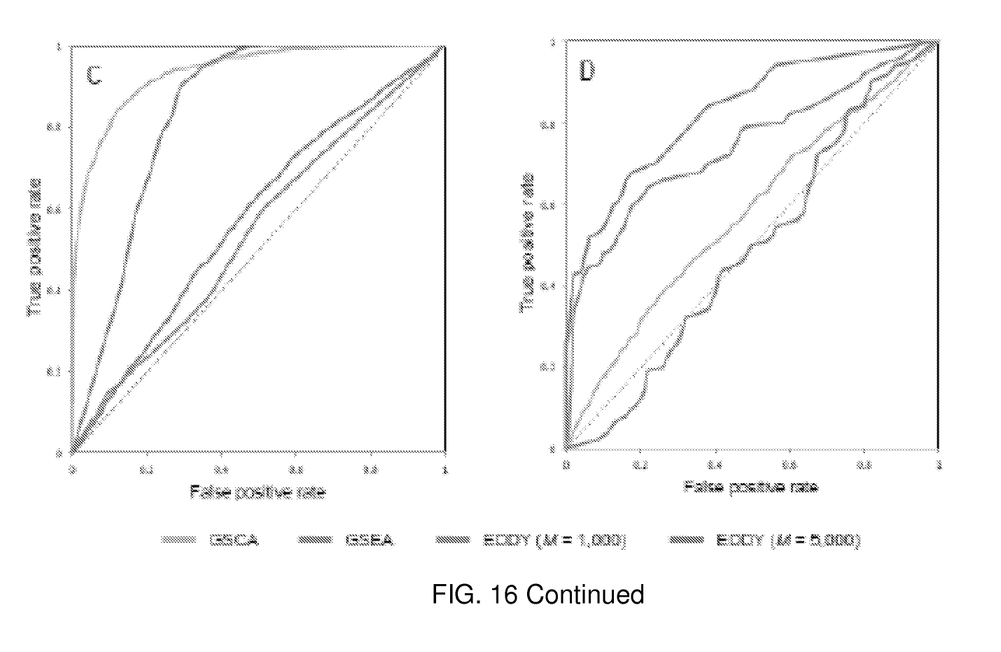

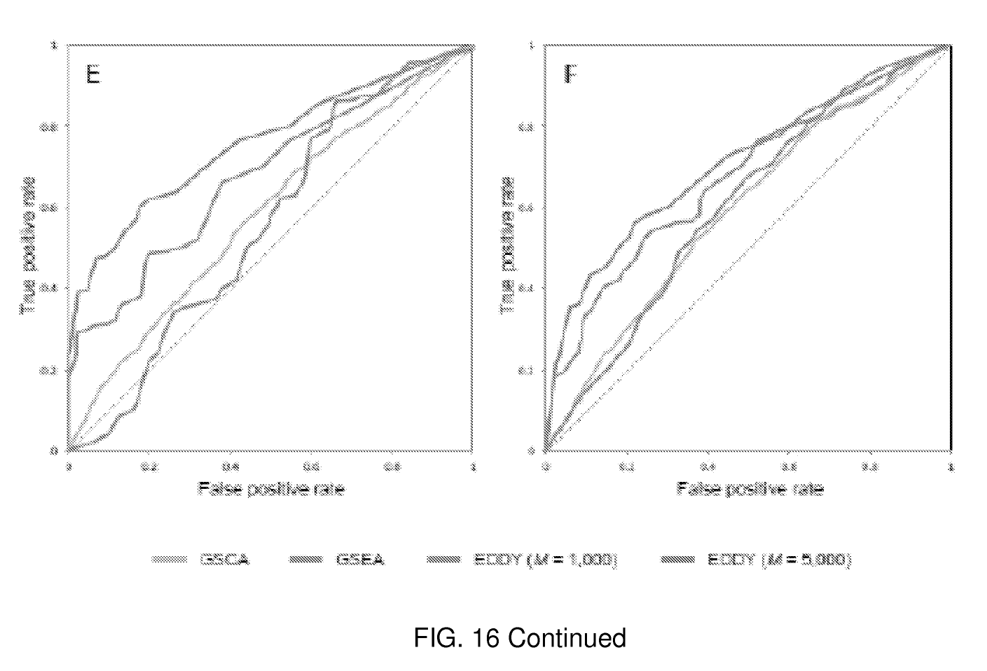

FIG. 16 depicts a series of graphs that illustrate the comparison of receiver operating characteristics (ROC) of GSCA, GSEA, and EDDY in identifying differential gene sets from simulated experiments. FIG. 16A depicts the results of a DEG-focused simulation, where v=10. FIG. 16B depicts the results of a DEG-focused simulation, where v=20. FIG. 16C depicts the results of a DEG-focused simulation, where v=30. FIG. 16D depicts the results of an interaction-focused simulation, where v=10. FIG. 16E depicts the results of an interaction-focuesed simulation, where v=20. FIG. 16F depicts the results of an interaction-focused simulation, where v=30.

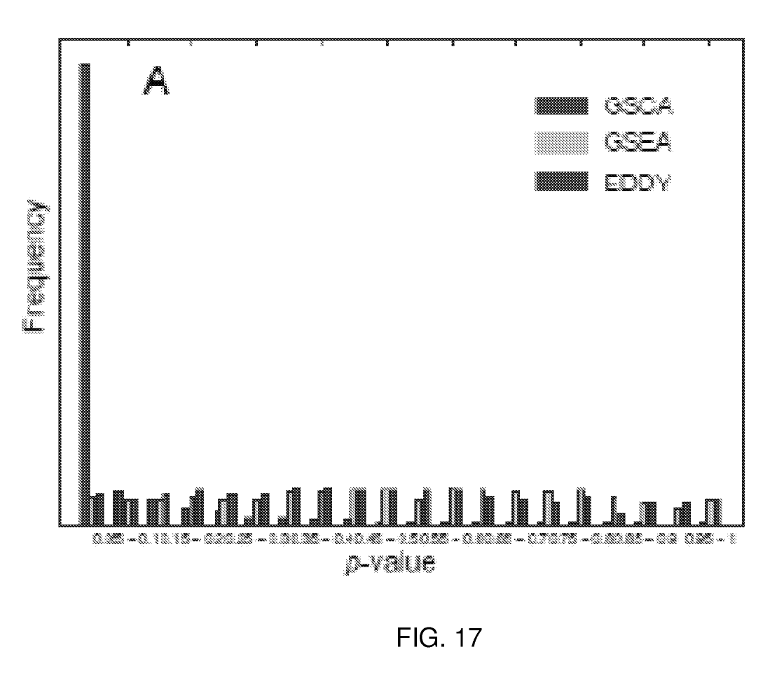

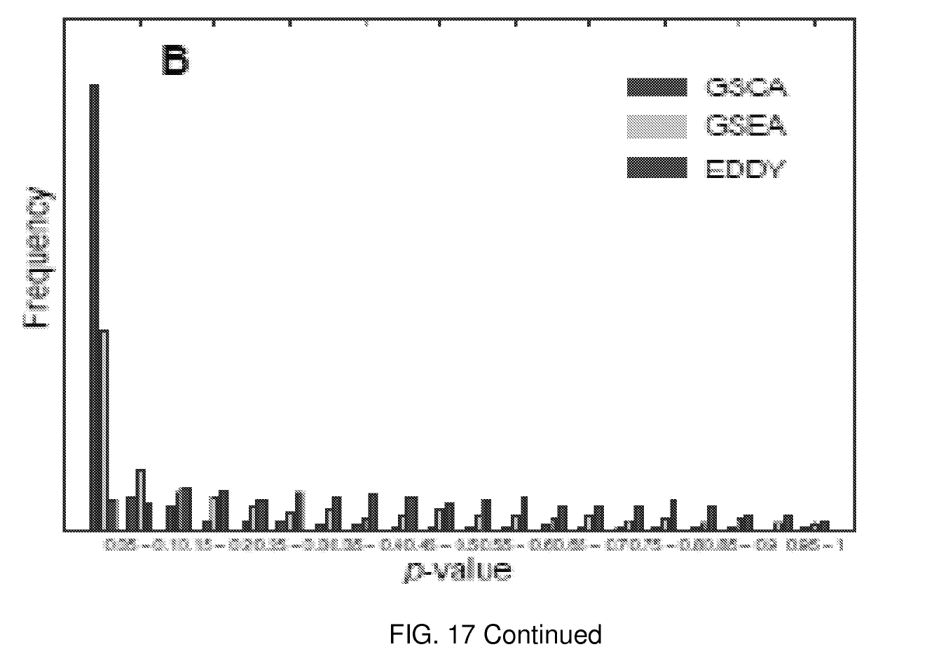

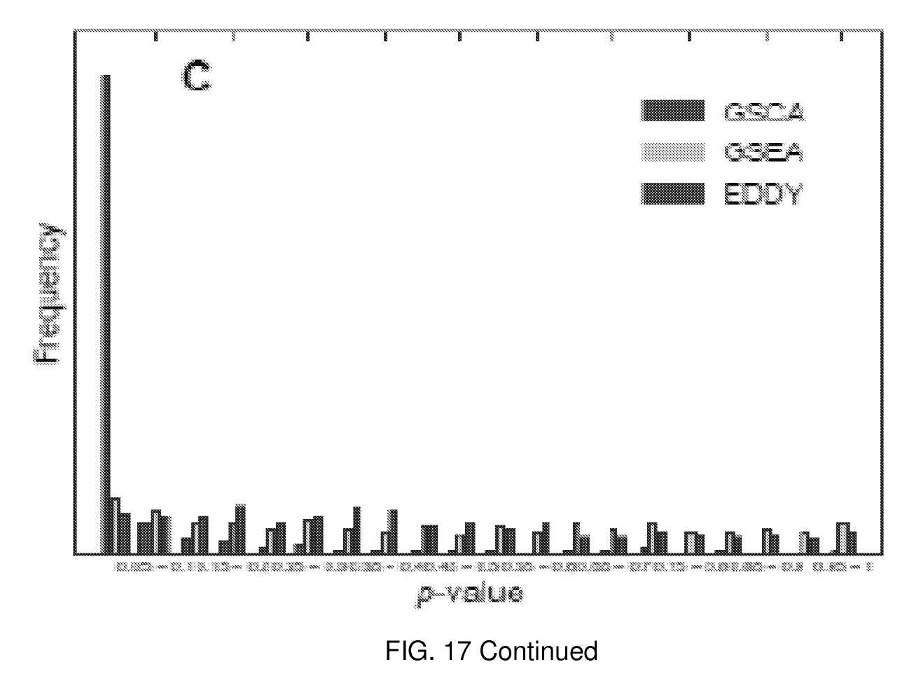

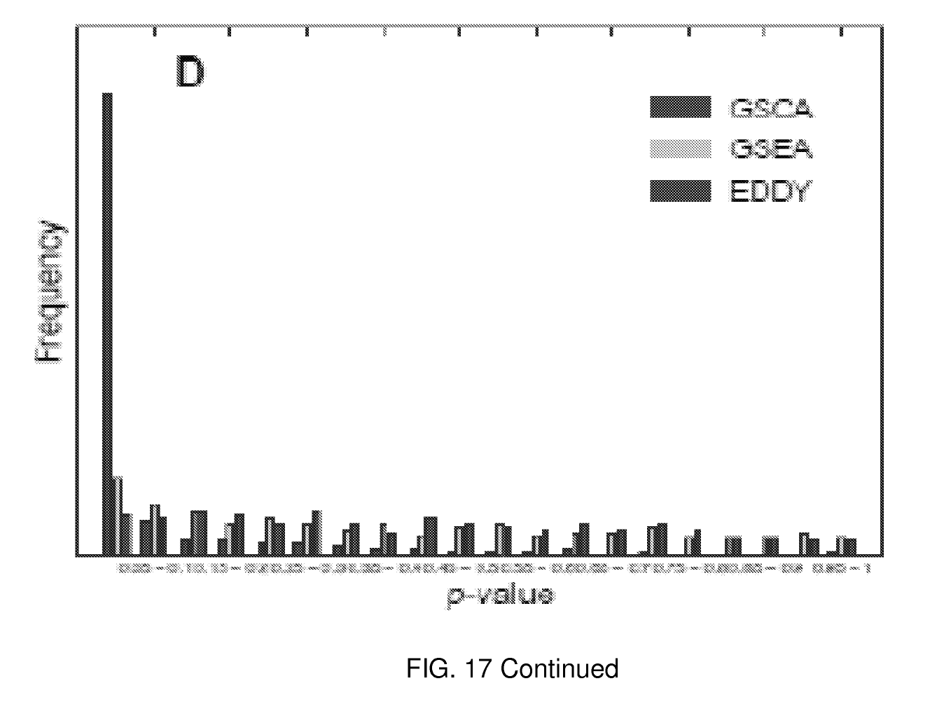

FIG. 17 shows a series of histograms of p-values from applying three different gene set test methods (EDDY, GSEA, and GSCA) to each subtype of TOGA GBM gene expression data. FIG. 17A represents data from testing the Classical subtype of GBM versus all non-Classical subtypes of GBM. FIG. 17B represents data from testing the Mesenchymal subtype of GBM versus all non-Mesenchymal subtypes of GBM. FIG. 17C represents data from testing the Neural subtype of GBM versus all non-Neural subtypes of GBM. FIG. 17D represents data from testing the Proneural subtype of GBM versus all non-Proneural subtypes of GBM.

Elements and facts in the figures are illustrated for simplicity and have not necessarily been rendered according to any particular sequence or embodiment.

### DETAILED DESCRIPTION

Aspects and applications of the invention presented herein are described in the drawings and detailed description of the invention. Unless specifically noted, it is intended that the words and phrases in the specification and the claims be given their plain, ordinary, and accustomed meaning to those of ordinary skill in the applicable arts.

Some embodiments of the invention comprise a system and method that can be used to provide a unique functionality of statistical testing to assess the overall differential dependency relationships of a set of discrete random variables between two conditions. As used herein, a “condition” is a set of observations, as related to target variables, wherein samples that share a condition may share specific characteristics. Some examples of a condition in biological applications can include a subtype of a disease, a group of patients that show response to a specific drug, or a group of patients with specific genomic characteristics. Some embodiments of the invention can be used to address which biological functions show distinct activities between different conditions. Some embodiments of the invention can be configured to aid in identifying novel biological functions through an analysis of distinct genetic interactions as compared between conditions. The new and unique benefits of embodiments of the invention in testing one or more genes are three-fold. First, the system and method evaluates the relationships / interactions between genes rather than the expression levels of the genes. Second, the system and method can evaluate the overall dependency relationship between one or more genes in a gene set. In particular, some conventional systems and methods generally independently evaluate individual interactions, thereby limiting their analytical power and applicability to gene sets. Finally, the system and method does not require prior knowledge regarding particular genetic interactions / relationships.

The idea of network-driven activities of biological functions has gained more interest, as more evidence is found that biological systems can show highly diverse activity patterns because genes can differentially interact across specific molecular contexts. The simplest approach to evaluate such differential interactions includes building separate networks for different conditions and comparing the networks. With the need for more statistical power to discriminate differential interactions, several studies proposed statistical methods to test the differentiality of individual interactions. In one study, an expected conditional F-statistic to test the differentiality of gene-gene co-expression between conditions was used. According to the differential correlation approach, a difference in correlation coefficients between a pair of variables across two conditions to identify differential interactions can be utilized.

In addition to these methods for individual differential interactions, there have been recent studies to identify differential sub-networks across conditions. The general idea of such an approach is utilizing already known genetic interactions as a ground truth network and overlaying observed genomic data (for example, mRNA expression) associated with different conditions to statistically evaluate genomic regions with differential genetic activities. One approach uses an edge-based scoring measure to identify condition-responsive protein-protein interaction sub-networks. Other approaches make use of a multivariate ANOVA scoring method to find differentially expressed sub-networks. One method employed, represented networks with activity weight matrices, and non-negative matrix factorization to find principal sub-networks. The COSINE method computes a score from both of gene expressions and available gene interactions to find condition-specific sub-networks.

In addition to these methods of utilizing already known interactions, a few methods have been proposed that operate without using known interactions. The differential dependency network (DDN) method infers a local dependency model to represent the topology around each variable for each condition. A permutation test is used to compute the significance of local topology change between conditions. Another approach models interactions coming into a variable with ordinary differential equations, and the difference in slopes of the models was compared across conditions to compute the difference in the magnitudes of local genetic relationships. These methods were designed to identify individual differential interactions or condition-specific sub-networks, but these methods were not designed to test gene sets for dependency variance across conditions.

As used herein, a “sample” may be any cell source from which DNA, including genomic, somatic, and germline DNA, RNA (i.e., any form of RNA), and/or protein may be obtained. For example, in some forms of cancer, a biological sample is often obtained from either the local site of the tumor or a distal site, if the cancer has metastasized. Tumor cells may be obtained by any method now known in the art or yet to be disclosed, including for example, surgical resection, laser capture microdissection, isolation from blood or other fluids including lavage fluid, or any other method capable of obtaining and, if necessary, concentrating tumor cells.

As used herein, the term “gene,” “nucleic acid,” “nucleic acid sequence,” “polynucleotide,” or similar terms, refers to a deoxyribonucleotide or ribonucleotide, oligonucleotide or polynucleotide, including single- or double-stranded forms, and coding or non-coding (e.g., “antisense”) forms. The term encompasses nucleic acids containing known analogues of natural nucleotides. The term also encompasses nucleic acids including modified or substituted bases as long as the modified or substituted bases interfere neither with the Watson-Crick binding of complementary nucleotides or with the binding of the nucleotide sequence by proteins that bind specifically, such as zinc finger proteins. The term also encompasses nucleic-acid-like structures with synthetic backbones. DNA backbone analogues provided by the invention include phosphodiester, phosphorothioate, phosphorodithioate, methylphosphonate, phosphoramidate, alkyl phosphotriester, sulfamate, 3′-thioacetal, methylene(methylimino), 3′-N-carbamate, morpholino carbamate, and peptide nucleic acids (PNAs); see Oligonucleotides and Analogues, a Practical Approach, edited by F. Eckstein, IRL Press at Oxford University Press (1991); Antisense Strategies, Annals of the New York Academy of Sciences, Volume 600, Eds. Baserga and Denhardt (NYAS 1992); Milligan (1993) J. Med. Chem. 36:1923-1937; Antisense Research and Applications (1993, CRC Press). PNAs contain non-ionic backbones_{;} such as N-(2-aminoethyl)glycine units. Phosphorothioate linkages are described, e.g., by U.S. Pat. Nos. 6,031,092; 6,001,982; 5,684,148; see also, WO 97/03211; WO 96/39154; Mata (1997) Toxicol. Appl. Pharmacol. 144:189-197. Other synthetic backbones encompassed by the term include methylphosphonate linkages or alternating methylphosphonate and phosphodiester linkages (see, e.g., U.S. Pat. No. 5,962,674; Strauss-Soukup (1997) Biochemistry 36:8692-8698), and benzylphosphonate linkages (see, e.g., U.S. Pat. No. 5,532_{;}226; Samstag (1996) Antisense Nucleic Acid Drug Dev 6:153-156). Such analogues can be employed in the preparation and use of antisense nucleic acids as is well known in the art, such as for the purpose of inhibiting transcription. Additionally_{;} the recitation of the term “gene” includes DNA, RNA, or DNA-RNA hybrids unless the context makes it dear that only one specific form of the nucleic add sequence is intended to be utilized. Moreover, the term “gene set” refers to more than one gene or nucleic acid. For example, “gene set” may refer to a grouping of two or more genes.

As described in greater detail herein, some embodiments of the invention may comprise an analysis of expression-related data. As used herein, “expression” encompasses all processes through which specific molecules may be derived from a nucleic acid template. Expression thus includes RNA transcription, mRNA splicing, protein translation, protein folding, post-translational modification, membrane transport, associations with other molecules, addition of carbohydrate moeties to proteins, phosphorylation, protein complex formation and any other process through which specific biological material may be made from a nucleic acid template.

Expression may be assessed by any of a number of methods used to detect material derived from a nucleic acid template used currently in the art and yet to be developed. Examples of such methods include any nucleic acid detection method including the following nonlimiting examples, microarray analysis, RNA in situ hybridization, RNAse protection assay, Northern blot, RT-PCR (reverse transcriptase PCR), and QRT-PCR (quantitative RT-PCR). Other examples include any process of detecting expression that uses an antibody including the following nonlimiting examples, flow cytometry, immunohistochemistry, ELISA, Western blot, and immuno-affinity chromatography. Antibodies may be monoclonal, polyclonal, or any antibody fragment including an Fab, F(ab)2, Fv, scFv, phage display antibody, peptibody, multispecific ligand, or any other reagent with specific binding to a target. Such methods also include direct methods used to assess protein expression including the following nonlimiting examples: HPLC, mass spectrometry, protein microarray analysis, PAGE analysis, isoelectric focusing, 2-D gel electrophoresis, and enzymatic assays. Samples from which expression may be detected include single cells, whole organs or any fraction of a whole organ, whether in vitro, ex vivo, in vivo, or post-mortem. Preferably the sample includes cells derived from a tumor.

Other methods used to assess expression include the use of natural or artificial ligands capable of specifically binding a gene or gene product (e.g., a peptide, polypeptide, or protein). Such ligands include antibodies, antibody complexes, conjugates, natural ligands, small molecules, nanoparticles, or any other molecular entity capable of specific binding to a marker. Antibodies may be monoclonal, polyclonal, or any antibody fragment including an Fab, F(ab)2, Fv, scFv, phage display antibody, peptibody, multispecific ligand, or any other reagent with specific binding to a marker. Ligands may be associated with a label such as a radioactive isotope or chelate thereof, dye (fluorescent or nonfluorescent,) stain, enzyme, metal, or any other substance capable of aiding a machine or a human eye from differentiating a cell expressing a marker from a cell not expressing a marker. Additionally, expression may be assessed by monomeric or multimeric ligands associated with substances capable of killing the cell. Such substances include protein or small molecule toxins, cytokines, pro-apoptotic substances, pore forming substances, radioactive isotopes, or any other substance capable of killing a cell.

Differential expression encompasses any detectable difference between the expression of a gene in one sample and/or condition relative to the expression of the gene in another sample and/or condition. Differential expression may be assessed by a detector, an instrument containing a detector, or by aided or unaided human eye. Examples include but are not limited to differential staining of cells in an IHC assay configured to detect a marker, differential detection of bound RNA on a microarray to which a sequence capable of binding to the marker is bound, differential results in measuring RTPCR measured in ΔCt or alternatively in the number of PCR cycles necessary to reach a particular optical density at a wavelength at which a double stranded DNA binding dye (e.g., SYBR Green) incorporates, differential results in measuring label from a reporter probe used in a real-time RTPCR reaction, differential detection of fluorescence on cells using a flow cytometer, differential intensities of bands in a Northern blot, differential intensities of bands in an RNAse protection assay, differential cell death measured by apoptotic markers, differential cell death measured by shrinkage of a tumor, or any method that allows a detection of a difference in signal between one sample or set of samples and another sample or set of samples.

The expression of the gene in a sample and/or condition may be compared to a level of expression predetermined to predict the presence or absence of a particular physiological characteristic. The level of expression may be derived from a single control or a set of controls. A control may be any sample from any condition with a previously determined level of expression. A control may comprise material within the sample or material from sources other than the sample. Alternatively, the expression of a gene in a sample may be compared to a control that has a level of expression predetermined to signal or not signal a cellular or physiological characteristic. This level of expression may be derived from a single source of material including the sample itself or from a set of sources. Comparison of the expression of the marker in the sample and/or condition to a particular level of expression results in a prediction that the sample and/or condition exhibits or does not exhibit the cellular or physiological characteristic.

As used herein, “differentiality” refers to a distinction or difference that exists and/or is detectable between any features when compared across different conditions. In some aspects of the invention, differentiality can refer to a detectable difference in a gene or a gene set in two different conditions. By way of example only, differentiality can refer to detectable distinctions or other detectable differences that are related to an interaction / relationship between genes or sets of genes.

As used above, “relationship” or “interaction” in the context of genes or a gene set refers to a statistically demonstrable association between two or more genes (i.e., gene sets) such that at least one gene may causally impact at least one other gene. In some aspects, the association between two or more genes may be based on a correlative or causal connection. For example, in the case of using data related to transcription of genes in different conditions, “relationship” or “interaction” refers to the statistically demonstrable association of two or more genes on a transcriptional level. In some embodiments, the association may be direct (e.g., one gene directly impacts another gene, such as in the case of transcriptional regulation) or indirect. In other words, in some contexts, the association may be at the level of transcriptional regulation. In other contexts, the statistically demonstrable association between the two or more genes may exist in a manner other than at the level of transcriptional regulation. In other embodiments of the invention, the system and method can be used in conjunction with protein-related data such that “relationship” or “interaction” may refer to translationally-related associations.

According to various embodiments of the invention a method for evaluation of dependency differentiality (EDDY) is provided, which is generally illustrated in FIG. 1. In some embodiments, EDDY can be configured as a statistical test that can be used to determine the differential dependency relationship of a set of discrete random variables between at least two conditions. In some aspects, for each condition being assessed, possible dependency network structures can be enumerated and the likelihoods of the dependency network structures are computed to represent a probability distribution of the dependency networks. The difference between the probability distributions of dependency networks between conditions is then computed, and the statistical significance of the difference between the probability distributions of the dependency networks is evaluated with random permutations of condition labels on the samples. As described in greater detail herein, the method has been evaluated through simulation studies, and was applied to the gene expression data of glioblastoma multiforme (GBM) from The Cancer Genome Atlas (TCGA) to analyze the functional difference between the four subtypes of GBM. The GBM test results have been compared to that of GSEA, which is considered a representative method of considering only differential expressions. The results demonstrate that the method according to some embodiments of the invention can identify novel gene sets that could not be found with the GSEA, while providing many results specific to the subtypes of GBM. Similarly, EDDY was compared to GSCA, which is an existing gene set test method for differential interactions. As described in greater detail herein, EDDY provided less-biased results that have potential to be more informative, relative to GSCA.

FIG. 1 shows the conceptual outline of EDDY. Initially, data (e.g., expression data) related to a target set of variables can be input into the EDDY system. Thereafter, distributions of network likelihoods can be computed and then divergence between the distributions of network likelihoods can be assessed. After calculation of the divergence, the statistical significance of the divergence values is determined. Specifically, the data can be rebuilt into randomly permuted conditions for which the divergence is evaluated, in the same manner as mentioned above. Thereafter, the original divergence values are compared to the divergence values from the random permutations of the rebuilt data to determine significance, as measured by a p-value.

### EXAMPLES

Herein below are set forth various embodiments of the present invention. It is anticipated that suitable modifications can be made thereto which will nonetheless remain within the scope of the invention. The invention shall therefore only be construed in accordance with the claims below and not any particular embodiment or example.

### Example 1

### Methods and Systems

### Approach

As illustrated in FIG. 1, in some embodiments of the invention, the method can compute the discrepancy between probability distributions of dependency network structures for a given set of variables. Moreover, the method can compute the probability distributions of dependency network structures across given samples of at least two different conditions, and then can evaluate the associated statistical significance. In particular, it is assumed that a set of variables V is given for the target of a test. For V, there are N (i.e., a finite number) possible dependency network structures g₁, g₂, . . . , g_{N} for the variables. If one considers a discrete random variable G that can have g₁, g₂, . . . , g_{N} as its discrete values, the posterior probability P (G|D_{C}) for the data D_{C} of a given condition C can represent the probability distribution of dependency network structures for V in the condition C. When two data sets, D_{C1} and D_{C2}, are given for two different conditions C₁ and C₂, the divergence between the two corresponding probability distributions P (G|D_{C1}) and P (G|D_{C2}) are computed as a measure of the difference between the conditions. This approach compares the best networks from different conditions by considering many possible dependency networks and the likelihoods of the dependency networks. The benefit of this comparison is a more reliable measure of discrepancy, especially when data is limited. As such, by using this comparison, there is a greater chance of finding many local optima for the best network. By considering multiple probable dependency networks instead of one local optimal network, this approach can represent a truer picture of dependencies. The statistical significance of the divergence is computed using a permutation approach, by repeating the random shuffling of condition labels C₁ and C₂ and computing the divergence to evaluate the probability of obtaining the original or larger divergence by random chance, as illustrated in FIG. 1.

Computing the Posterior Probability of each Dependency Network Structure

Evaluating the probability distribution of P(G|D_{C}) of a discrete random variable G requires computing the posterior probability Pr(gᵢ|D_{C}) of each dependency network structure, where gᵢ(1≦i≦N) for the condition C. The direct computation of the posterior probability of a model (gᵢ) given observation (D_{C}) is not necessarily straightforward. As such, the approach uses these likelihoods to compute the posterior probability. In using Bayes' theorem, the posterior probability Pr(gᵢ|D_{C}) can be re-written as follows:

$$Pr ( {g}_{i} \vert {D}_{C} ) = \frac{Pr ( {D}_{C} \vert {g}_{i} ) Pr ( {g}_{i} )}{Pr ( {D}_{C} )} , \qquad ( 1 )$$

where Pr(D_{C}|gᵢ) is the likelihood. Without assuming any preference on the dependency network structures, once can take a uniform prior for Pr(gᵢ) and consider it a constant. As Pr(D_{C}) is also constant,

Pr(gᵢ|D_{C})=αPr(D_{C}|gᵢ),

where α=Pr(gᵢ)/Pr(D_{C}) is the same constant for any i. Given that the sum of probabilities is one,

$${{\sum }_{k = 1}}^{N} Pr ( {g}_{k} \vert {D}_{C} ) = α {{\sum }_{k = 1}}^{N} Pr ( {D}_{C} \vert {g}_{k} ) = 1 \qquad ( 3 )$$

From the equations (2) and (3),

$$Pr ( {g}_{i} \vert {D}_{C} ) = \frac{Pr ( {D}_{C} \vert {g}_{i} )}{{\sum }_{k = 1}^{N} Pr ( {D}_{C} \vert {g}_{k} )} \qquad ( 4 )$$

From this approach, the posterior probability Pr(gᵢ|D_{C}) is computed based on the likelihoods. In some embodiments, the method comprises considering only the discrete random variables for V and directed acyclic graphs (DAG) for the dependency network structures of G. The computation of likelihood Pr(D_{C}|gᵢ) is done using the Bayesian Dirichlet equivalence uniform (BDeu) scoring method based on the Bayesian network model.

### Approximate Computation of Probability Distribution for Dependency Network Structures

In some aspects, the computation of the probability distribution P (G|D_{C}) requires the enumeration of all possible N dependency network structures, g₁, . . . , g_{N}, and subsequent computation of the associated posterior probabilities, Pr(gᵢ|D_{C}) (1≦i≦N). Under some conditions, an exact computation is possible for a of small number of variables, but it becomes less feasible as the number of variables increases. For example, the possible number of DAGs for five variables is about 29,000, but it becomes about 4.2×10¹⁸ for 10 variables. For this reason, a heuristic approach to approximate the probability distribution of P (G|D_{C}) can be employed with some embodiments of the invention. In this approach, it can be assumed that the probabilities of M (<<N) dependency structures are significantly greater in either C₁ or C₂, and the rest of the dependency structures have similar low probabilities in both of the conditions. As such, these lower probabilities of dependency structures can be ignored as these remaining dependency structures make little difference between the conditions. To reduce bias for both conditions, M/2 dependency structures are chosen from the condition C₁ and the other M/2 are chosen from the condition 0₂.

Selecting the top M/2 dependency network structures with the highest probabilities from a condition also includes computing the probabilities of some or all dependency network structures, which can render this approximate approach ineffective. To reduce computational complexity, a method was used that proposes probable dependency structures by independently evaluating each dependency between two or more variables. In this method, a χ²-test is applied to test the independency between every pair of two variables Vᵢ and Vⱼ (∈ V), which leads to obtaining the resultant p-value pᵢⱼ(=pᵢⱼ). When a probable dependency structure gk is proposed for D_{C}, an edge e between Vᵢ and Vⱼ is included with the following probability Prₚᵣₒₚₒₛₑ(i;j|D_{C}):

Prₚᵣₒₚₒₛₑ(;j|D_{C})=(1−pᵢⱼ)^{λ},

where λ≧1. With this definition of edge inclusion probability, an edge between two variables will be included in the proposed structure with higher probability when the dependency test between the two variables yields a lower p-value. Either direction of the edge eᵢⱼ or eⱼᵢ is randomly chosen with the same probability of 0.5 as long as it does not violate the acyclic property of DAG in gk. To reduce computational complexity in evaluating DAG structures, the maximum number of incoming edges is limited to a predetermined K. This method is specifically described in Algorithm : StructurePropose (as illustrated below). This pairwise dependency-based method of structure proposal has a limitation in identifying combinatorial dependencies. However, the actual computation of network structure likelihoods is done in consideration of such combinatorial dependencies (with the BDeu scoring method), and sampling multiple network structures can further diminish this limitation.

Algorithm StructurePropose

```
Input: V,D_{c},λ(≧1),K
Output: A probable DAG g for V
  1: g ← An empty DAG with vertices of V and no edge
  2:
  3: for all pair of Vᵢ and Vⱼ in V do
  4:  Evaluate pᵢⱼ using a statistical independency test
  5:  Pr_{RandomThreshold} ← a random number from a uniform distribution of
    [0,1]
  6:
  7:  if Pfₚᵣₒₚₒₛₑ(k,j|D_{c}) ≧ Pr_{RandomThreshold} then
  8:  e ← Random pick between eᵢⱼ and eⱼᵢ with equal probability 0.5
  9:  Put e in g
10:
11:  if g is not a DAG or Vᵢ or Vⱼ has more than K incoming edges
      then
12:  Remove e from g
13:  end if
14:  end if
15: end for
16:
17: return g
```

After using the aforementioned methods to collect up to M network structures for the cases of large numbers of variables, the probability distributions P (G|D_{C1}) and P (G|D_{C2}) are computed by evaluating the likelihoods of network structures, as described in Algorithm: ComputeDistribution.

Algorithm ComputeDistribution

```
input: V,D_{c}_{₁},D_{c2},λ(≧1),M(<<N),K
Output:  P(G|D_{c}_{₁}) ,  P(G|D_{c2})  (where
P(G|D_{c}_{₁}) = {[gᵢ,Pr(gᵢ|D_{c}_{₁})]|1 ≦ i ≦ L,L ≦ M})
  1: P(G|D_{c}_{₁}) ←
  2: P(G|D_{c2}) ←
  3:
  4: if M = N then
  5:  for all possible gᵢ for V do
  6:  P(G|D_{c}_{₁}) ← P(G|D_{c}_{₁}) ∪ ([gᵢ,Pr(gᵢ|D_{c}_{₁})]}
  7:  P(G|D_{c2}) ← P(G|D_{c2}) ∪ ([gᵢ,Pr(gᵢ|D_{c2})]}
  8:  end for
  9: else
10:  G←
11:
12:  for i ← 1 to M/2 do
13:  g₁ ← StructurePropose(V,D_{c}_{₁},λ,K)
14:  g₂ ← StructurePropose(V,D_{c2},λ,K)
15:  G ← G ∪ (g₁)
16:  G ← G ∪ (g₂)
17:  end for
18:
19:  for all g, ε G do
20:  P(G|D_{c}_{₁}) ← P(G|D_{c}_{₁}) ∪ {[gᵢ,Pr(gᵢ|D_{c}_{₁})]}
21:  P(G|D_{c2}) ← P(G|D_{c2}) ∪ {[gᵢ,Pr(gᵢ|D_{c2})]}
22:  end for
23: end if
24:
25: return P(G|D_{c}_{₁}) and P(G|D_{c2})
```

Computing the Divergence between Conditions and Statistical Significance

In some embodiments, the method may comprise measuring the divergence between the conditions C₁ and C₂ using the Jensen-Shannon (JS) divergence. In particular, once the probability distributions of dependency network structures P (G|D_{C1}) and P (G|D_{C2}) are computed, the divergence between the conditions C₁ and C₂ is measured using JS divergence, which is a popular method of measuring the divergence between two discrete probability distributions. Once the JS divergence value, JS, is obtained, the statistical significance of JS is computed using a permutation approach. Condition labels of C₁ and C₂ are randomly re-assigned to the samples of D_{C1}∪D_{C2} to build permuted sample sets D′C₁ and D′C₂, and the same process is applied to compute a new divergence JS′. If JS′ is larger than or equal to JS for t times out of T random permutations, the statistical significance p-value of JS is defined as t/T. This whole process is specifically defined in Algorithm : EDDY.

Algorithm 1 EDDY

| Input: V,D_{C}_{₁},D_{C}_{₂},λ(≧1),M(<<N),T,K | |
|---|---|
| Output: JS,p | |
| 1: | {P(G\|D_{C}_{₁}),P(G\|D_{C}_{₂})] ← ComputeDistribition(V, |
| | D_{C}_{₁},D_{C}_{₂},λ,M,K) |
| 2: | JS ← JensenShannon(P(G\|D_{C}_{₁})\|\|P(G\|D_{C}_{₂})) |
| 3: | t ← 0 |
| 4: | |
| 5: | for i ← 1 to T do |
| 6: | Build D_{C}_{₁}^{r} and D_{C}_{₂}^{r} by randomly shuffling the |
| | condition labels |
| 7: | {P(G\|D_{C}_{₁}^{r}),P(G\|D_{C}_{₂}^{r})} ← ComputeDistribution(V, |
| | D_{C}_{₁}^{r},D_{C}_{₂}^{r}λ,M,K) |
| 8: | JS^{r} ← JensenShannon(P(G\|D_{C}_{₁}^{r})\|\|P(G\|D_{C}_{₂}^{r})) |
| 9: | |
| 10: | if JS^{r} ≧ JS then |
| 11: | t ← t + 1 |
| 12: | end if |
| 13: | end for |
| 14: | |
| 15: | p←t/T |
| 16: | return JS and p |

### Example 2

### Simulation Experiment

### Environment

Simulation experiments were conducted to evaluate the ability of EDDY to discriminate between two different conditions. In the simulation experiment, |V|=v discrete random variables were considered that can have three possible discrete values (−1, 0, 1). A Bayesian network B₀ with 2v edges was randomly built with the v variables, and d samples were generated from B₀ to constitute a data set D₀. To generate a data set of another condition for comparison, Bₛ was built by randomly removing s(≦2v) edges from B₀, and d samples were generated from Bₛ for Dₛ. In the process of edge removal, the conditional probability table of a variable that is affected by the edge removal is randomly re-initialized. This simulation experiment demonstrates that the divergence JS increases and the statistical significance p-value decreases as s, which represents the distance between two data sets, in the sense of dependency relationship, increases.

Different numbers of variables were tested with v=5, 10, 20, and 50, as well as varying sample size with d=50, 200, and 500. For the parameters of EDDY, M was chosen among 50, 200, 1,000, 3,000, 5,000, and Nᵥ (the number of all possible DAG structures for v nodes) according to v that can represent the size of a problem. λ=1 and T=1, 000, and K=3, 5, v−1 (which is the maximum value) were used throughout the simulation experiment. K=3 and 5 were used to evaluate the effect of limiting the incoming edges on the performance, which is detailed in FIGS. 14 and 15. For each case of testing D₀ versus Dₛ, the processes of building random Bayesian networks B₀ and Bₛ, generation of data D₀ and Dₛ, and applying EDDY was repeated 100 times to compute the average JS and p-values.

Another network comparison scenario was also tested, where Br₀ was built instead of Bs by randomly relocating the edges in B₀, which was then used as a comparison for B₀. This scenario represents more general cases of comparison, where the networks generating given data sets may have more complex interaction discrepancies than simply missing interactions. For this simulation experiment, the number of edges in B₀ was randomly determined to be between 0 and the maximum possible number.

### Results

FIGS. 2-5 illustrate the capacity of EDDY to generate JS and p-values by varying s, through the use of different parameters and data amounts. In general, JS divergence values increase and corresponding p-values decrease as the discrepancy in dependency increases between the Bayesian networks from which D₀ and Dₛ were generated. This meets the expectation that the method returns higher discrepancy (JS) and stronger statistical evidence for the comparison of more distinct data sets.

Similarly, regarding the number of dependency network structures, the use of a larger M gives greater JS divergence values and lower p-values, as illustrated in FIGS. 2-5. This result occurs because considering more dependency network structures improves the approximation of probability distributions P(G|D). As such, EDDY can distinguish two different data sets more correctly with these greater values. The effect of using more samples for the test is also illustrated in FIGS. 2-5. When smaller numbers of samples was used (e.g., d=50), the increase of JS and the decrease of p-values is less clear even if the discrepancy s in dependency is increased between the networks behind the data sets.

However, as the available number of samples increases (e.g., d=200 and 500), the pattern of increasing JS and decreasing p-values becomes more distinct. This phenomenon indicates that the performance of EDDY in discriminating distinct data sets is improved as the number of available samples for a test is similarly increased. Another observation is that more dependency network structures (i.e., a larger M) may need to be considered as the problem size increases (i.e., larger numbers of variables). Referring to FIGS. 2 and 3, EDDY shows properly increasing JS and decreasing p-values with an increasing s when there are 5 to 10 variable cases, M=50 to approximately 1,000 dependency network structures. Such patterns, however, are not comparably clear for the case of 20 variables with the same amount of dependency network structures and sample sizes (i.e., d=50 and 200 in FIG. 4). Using more samples (i.e., d=500 in FIG. 4) made JS and p-values more distinguishable, but increasing the amount of dependency network structures for consideration (M=3,000 and 5,000) resulted in EDDY providing a much clearer pattern of varying JS and p-values. In addition, using larger M values also produced reasonable performances for the case of 50 variables (FIG. 5). This result likely occurs because the number of possible dependency network structures is significantly increased as the number of variables increases. Thus, it requires more dependency network structures to be considered for proper approximation of probability distributions P(G|D) in at least some embodiments of the invention.

In addition to the aforementioned characteristics of JS and p-values, EDDY's sensitivity was also observed in determining statistical significance with varying s. In particular, out of 100 repetitions of EDDY for each comparison of D₀ versus Dₛ, the ratio of cases with a p-value <0.05 was computed. FIGS. 6-9 show the ratio of statistically significant cases by varying the discrepancy s. As expected from the p-value plots in FIGS. 2-5, the ratio of statistically significant cases increases with increasing network discrepancy s. Similar to JS and p-values, increasing the number of samples or the number of dependency network structures of consideration enables EDDY to identify more statistically significant relationships / interactions. In this experiment, EDDY identified a relatively small number of nodes. In this case, λ=1 and T=1, 000 were used throughout the simulation experiment. For each case of testing D₀ versus Dₛ, the processes of building random Bayesian networks B₀ and Bₛ, generation of data D₀ and Dₛ, and applying EDDY was repeated 100 times to compute the average JS and p-values.

As previously mentioned, FIGS. 2-5 show JS and p-values determined by applying EDDY with different parameters and data amounts by varying s. In particular, these figures illustrate JS divergence and p-values determined by applying EDDY to compare D₀ and Dₛ using (FIG. 2) v=5 variables; (FIG. 3) v=10 variables; (FIG. 4) v=20 variables; and (FIG. 5) v=50 variables. Each point in a plot represents the average from 100 repetitions. Error bars indicate the 95% confidence interval of the average. In general, JS divergence values increase and corresponding p-values decrease as the discrepancy in dependency increases between the Bayesian networks from which D₀ and Dₛ were generated. This meets the expectation that the method returns higher discrepancy (JS) and stronger statistical evidence for the comparison of more distinct data sets.

Regarding the number of dependency network structures, using a larger M gives higher JS divergence values and lower p-values. This result occurs because considering more dependency network structures improves the approximation of probability distributions P(G|D). Therefore, EDDY can distinguish two different data sets in a more correct manner, relative to conventional systems. The effect of using more samples for the test is also evident from FIGS. 2-5. When smaller number of samples (e.g., d =50) was used, the increase in JS and the decrease in p-values is less clear even if the discrepancy s in dependency is increased between the networks behind the data sets. However, as the available number of samples increases, the number of statistically significant cases (true positive cases) increases when the number of available samples or computational capacity is limited (small d or small M), or when the size of a problem is large (large v). Considering, however, that statistically significant cases from the test of D₀ versus D₀ (the cases of s=0 in FIGS. 6-9) correspond to false positives, it is important to note that EDDY provides very low false positives regardless of conditions (i.e., near 0% cases are reported to be statistically significant for s=0).

In summary, these results demonstrate the ability of EDDY to distinguish data sets of different conditions correlated with the discrepancy in dependency relationships associated with the data sets. It was also observed that increasing the number of available samples or the number of dependency network structures of consideration improves performance, while requiring more computations. One important benefit of EDDY is its conservative behavior of giving low false positives, thereby resulting in trustworthy results even for challenging problems.

In addition, the effect of using smaller K values for selected cases was also evaluated. Limiting the number of incoming edges to each variable restricts possible DAG structures, which can thus limit the ability of EDDY to correctly approximate the probability distribution of dependency network structures. As such, limiting K to smaller values gives similar effects with consideration of fewer dependency network structures (a smaller M value) in approximating the network distribution, which results in a relatively lower discrepancy, higher p-values, and lower calling rates of statistically significant cases, as illustrated in FIGS. 14 and 15.

### Example 3

### Application

### Data and Environment

According to some embodiments of the invention, the method (i.e., EDDY) may be conducted, performed, and/or executed using high-performance computers (e.g., cluster computers), as the steps may require heavy computation. In the following example, EDDY was used to identify biological functions and pathways that show distinct genetic relationships/interactions in the subtypes of glioblastoma multiforme (GBM). Gene expression data of GBM was obtained from The Cancer Genome Atlas (TCGA) for 202 samples with four previously reported GBM subtypes (54 Classical, 58 Mesenchymal, 33 Neural, and 57 Proneural), as well as 10 normal samples. The expression of 17,814 genes in the GBM samples was standardized to z-scores using the 10 normal samples as a reference. The standardized expression values were quantized to three discrete values of “1” (over-expression compared to normal), “0” (no-change compared to normal), and “−1” (under-expression compared to normal) by using one standard deviation as a threshold.

EDDY and two conventional methods, GSEA and GSCA, were applied to the TCGA GBM gene expression data to identify subtype-specific gene sets. The tests were done by comparing samples of a particular subtype S (e.g., classical, mesenchymal, neural, and proneural) versus the rest of the samples to identify gene sets that show distinct genetic relationships in the subtype S. For gene sets of test targets, 2,101 canonical pathway gene sets and Gene Ontology (GO) gene sets of biological process and molecular function were collected from MSigDB (Molecular Signatures Database). In testing each gene set for a subtype versus the remaining subtypes using EDDY, λ=1 and M=5, 000 dependency network structures of consideration, T=1,000 permutations, and K=3 were used. In addition, genes with changes in less than 10% of the samples after quantization were filtered out, resulting in 13,884 genes for analysis. Obtained p-values were false discovery rate (FDR) corrected using the Benjamini and Hochberg's method, and gene sets with FDR-corrected p-value <0.05 were declared to be statistically significant.

For comparison with conventional methods based on differential gene expression, GSEA was also applied to identify gene sets for each subtype. For GSEA, the standardized gene expression data was used without quantization. Of the 2,101 gene sets, 2,067 gene sets (98.4%) with up to 500 genes were tested using GSEA. In running GSEA for each gene set, 1,000 permutations were applied. From the results, p-values were FDR-corrected using the Benjamini and Hochberg's method, and the same p-value threshold 0.05 was used for statistical significance.

In addition, the EDDY-derived results were also compared with GSCA, which is a method that evaluates the differentiality of interactions given a gene set, but based on simple pairwise correlations rather than assessing global topology of network structures. For GSCA, Pearson correlation coefficients were used as correlation measures, and 1,000 permutations were applied to compute statistical significance of measure discrepancy. The FDR-corrected p-value 0.05 was used as a threshold for statistical significance. In applying GSEA and GSCA, the standardized gene expression data was used without quantization.

TABLE 1
The number of statistically significant gene sets for each subtype.

| Method | Classical | Mesenchymal | Neural | Proneural |
|---|---|---|---|---|
| EDDY | 13 | 10 | 22 | 22 |
| GSEA | 1 (0) | 245 (1) | 6 (0) | 3 (0) |
| GSCA | 1,590 (11) | 1,432 (7) | 1,681 (21) | 1,563 (17) |

The number of common cases with EDDY in indicated in the parentheses.

### Results

Table 1 lists the number of statistically significant gene sets identified with the three different methods for each subtype. EDDY and GSEA produced different results, as EDDY identified 10 to 22 gene sets for each subtype, while GSEA identified 245 gene sets for the Mesenchymal subset, but just a few for other subtypes (between 1 and 6 gene sets). Moreover, there is only one common gene set (for Mesenchymal) between the results obtained using these two methods. A possible hypothesis of GSEA identifying a large number of gene sets for the Mesenchymal subtype is that this subtype is a most differentiated form of GBM (physiologically or genotypically) (Verhaak et al., 2010) and many genes are differentially expressed in the Mesenchymal subtype compared to other subtypes. Compared to GSEA, the results of EDDY are less biased toward a specific subtype.

Compared to the other two methods, GSCA identified more gene sets as significantly significant, from 68% to 80% of the tested gene sets, rendering the results nearly non-informative. Referring to FIGS. 10A-10D and 17A-17D, the p-values from GSCA are much closer to zero in general than the p-values of the data derived from EDDY and GSEA. In order to better understand the GSCA-derived results that provided too many cases of low p-values, the p-values of the results from the EDDY and GSEA experiments were compared along with the sizes of gene sets, where both methods target differential genetic interactions. FIGS. 11A-11D illustrate p-values from the methods along with the size of engine sets. As such, it can be seen that GSCA reports much lower p-values as the size of gene sets increases, while the result from EDDY does not show such bias related to the size of the gene sets. This characteristic of GSCA has been previously disclosed by the developers of GSCA, where it has been noted that GSCA could be sensitive to the sum of minor local correlation changes from any gene interactions of a large gene set. This results in GSCA reporting lower p-values for large gene sets, which can lead to a potentially high false positive rate, as seen for the GBM data set. In comparison, EDDY comprises conservative characteristics that result in a low false positive rate, as shown from the simulation experiments. Even though EDDY may give results of lower sensitivity than GSCA, the results from EDDY can be more informative once identified as statistically significant due to such a low false-positives rate. In addition, the sensitivity of EDDY can be increased with additional computational resources without increasing false positives, as illustrated in the simulation experiments.

FIG. 12 shows the relative proportions of statistically significant gene sets identified with EDDY, based on relevant functions of the gene sets. The size of each area is proportional to the number of gene sets that are related to the corresponding function. White blank areas indicate the proportion of gene sets with functions other than the specified functional groups. In particular, FIG. 12A illustrates gene sets related to the Classical subtype; FIG. 12B illustrates gene sets related to the Mesenchymal subtype; FIG. 12C illustrates gene sets related to the Neural subtype; and FIG. 12D illustrates gene sets related to the Proneural subtype.

All four GBM subtypes are associated with gene sets of biological functions that are well-known with respect to general cancer biology, including as cell cycle-related genes, immune system-related genes, and signal transduction-related genes. In addition to the cancer-generic functions, some functional groups of genes are specifically associated with different subtypes. For example, gene sets related cell migration/structure were identified as related to the Mesenchymal subtype (FIG. 12B). This observation coincides well with the characteristics of the Mesenchymal subtype of GBM, where cancer cells go through an epithelial-mesenchymal transition (EMT) and show migrative behavior. In addition, of the four GBM subtypes, the Neural subtype is the only subtype to include gene sets that are associated with DNA damage repair (FIG. 12C). Considering that the failure of the DNA-repair mechanism can lead to the cancer initiation through unregulated cell division, a viable next step may include an investigation into the activities of DNA repair functions in the Neural subtype to further elucidate this connection with potential causes of this subtype. Another observation is that only the Neural and Proneural subtypes are associated with gene sets related to apoptosis, and the cause and effect of this abnormal activity of apoptotic gene sets in these two subtypes could also be the subject of future study.

Each gene set was further investigated and a few cases were found that are consistent with previous studies that were not identified with GSEA. Specifically, as a result of the application of EDDY, the genetic relationships of three selected gene set pathways were found to be distinct with statistical significance between a particular subtype and the remaining subtypes, as illustrated in FIGS. 13A, 13B, and 13C. To present an intuitive visualization of the magnitude of the difference that exists regarding the dependency relationships, a representative dependency network of the each noted pathways was composed that shows subtype-specific, non-subtype specific (specific to the other samples of the subtype), and common dependencies. In the process of applying EDDY to the data, M/2 dependency network structures were collected. For each case, the frequency of edge connection from the M/2 collected dependency network structures was evaluated for every gene-gene pair. If an edge existed in more than 95% of the dependency network structures, the edge was included for visualization in FIGS. 13A, 13B, and 13C.

As illustrated in FIGS. 13A, 13B, and 13C, genes in three pathways have many changes in dependency relationships between each corresponding subtype and non-subtype cases. However, individual genes do not show clear differential expression between each subtype and non-subtype cases, as shown in the heat maps of FIGS. 13A, 13B, and 13C. This implies that the dependency relationships between genes can be significantly different across conditions even when the overall expression of individual genes does not show a clear difference. Thus, using EDDY can be a better approach than using differential gene expression-based methods, such as GSEA, for such cases.

FIG. 13A illustrates the tumor suppressor ARF pathway gene set identified by comparing samples with the Classical subtype with samples with non-Classical subtype using EDDY. FIG. 13A illustrates the dependency relationships between genes in the ARF pathway. Dependency relationships that exist only in non-Classical subtypes are represented with dotted edges. Dependency relationships that exist only in the Classical subtype are represented with solid edges. Dependency relationships that were observed in both Classical and non-Classical subtypes are denoted with dashed edges. FIG. 13A also illustrates a heat map of standardized expression values for the ARF pathway genes.

The EDDY-based analysis of the ARF pathway gene set is in line with the findings of a previous study, where it was reported that there is a focal 9p21.3 homozygous deletion targeting CDKN2A in the Classical subtype. As a result, the RB pathway is almost exclusively affected through the CDKN2A deletion. This relationship between the CDKN2A deletion and the RB protein in the Classical subtype can be seen in FIG. 13A, where CDKN2A lost many dependency relationships with other genes in the Classical subtype (dotted edges), possibly due to the aforementioned deletion. However, the RB1 relationship is the only dependency relationship that CDKN2A acquired in the Classical subtype.

FIG. 13B illustrates the G2 pathway gene set and FIG. 13C shows the p53 gene set, where both were identified from testing Proneural subtype samples versus non-Proneural subtype samples. It was notes that these two cases can be related to the p53 mutation enrichment in the Proneural subtype, which has been previously reported. From these two pathway gene sets, p53 lost all of its dependencies with other genes in the Proneural subtype, possibly due to the mutation. Significantly, the use of GSEA alone did not detect any of the aforementioned dependency relationships.

### Example 4

### Comparison of EDDY with other Methods by Simulated Experimental Model

In order to show the benefits and distinguished characteristics of EDDY, the capability of EDDY to identify differential gene sets using simulated data sets was compared with that of other methods (GSEA and GSAC). As previously mentioned, there have been several studies that compare multiple gene set test methods that include the use of simulated data sets. The test configurations vary, with the number of samples d in each condition from 20 to 500, the total number of genes from 100 to 1,000, the size of each gene set v from 10 to more than 40. However, the simulation tests all used the same method to generate synthetic gene expression data assuming multivariate normal distributions and using covariance matrices, where the expression values of a gene in a condition is represented with a normal distribution with mean p and covariances with other genes. A differentially expressed gene (DEG) between two conditions is represented with two different mean values p1 and p2 in two corresponding conditions, and differential gene sets between conditions is often defined by controlling the number of DEGs. This scenario of data generation is DEG-focused, as each gene is assumed to have a unimodal distribution in each condition, and differential gene sets are defined according to the amount of DEGs. Such a scenario can be appropriate in comparing methods focused on DEGs as did the previously mentioned studies. However, there is a limitation in comparing methods focused on gene interactions because an interaction between two genes does not necessarily require unimodality in the respective expression levels. For this reason, two different scenarios of synthetic gene expression data generation were prepared, where the first scenario is a DEG-focused simulation like the previous studies and the second scenario is an interaction-focused simulation.

In Scenario I (i.e., the DEG-focused simulation), the expression levels of a gene set with v genes for a condition is generated from a multivariate normal distribution and a covariance matrix. The expression levels of a gene Vi in the gene set for the condition Ck is defined with a normal distribution with the mean p and variance 1. The covariance (Vi ,Vj) between Vi and Vj is randomly set from a normal distribution with mean 0 and variance 0.1, assuming near zero correlation between genes in order to make a situation where DEG-focused methods can be preferred. When a gene Vi is a DEG between two different conditions C1 and C2, Vi is set to have different mean values between conditions. Otherwise, Vi is set to have the same mean value. The same covariance matrix is used for both conditions. For one synthetic data set, 50 differential gene sets and 50 non-differential gene sets were prepared, where each gene set included v genes. The ratio of DEGs in a differential gene set is randomly set to a value higher than 2r, while it is lower than r in a non-differential gene set. Total 10,000 genes were generated, and the rest of 10,000-100r genes were randomly generated by repeating the same process of generating expressions for v genes, while keeping the ratio of DEGs in 10,000 genes to r. Different sizes of gene sets were tested with v=10, 20, and 30, p was randomly chosen between 1 and 3, and r=0.2 was used throughout the experiment.

In Scenario II (i.e., the interaction-focused simulation), the expression levels of a gene set for a condition was generated from a Bayesian network model with continuous values. The expression levels of a gene set with v genes for the condition Ck was generated from a randomly built Bayesian network model Bk, where each node corresponds to a gene, 2v edges were randomly assigned, and conditional probability tables were randomly initialized. For computational simplicity in data generation, each node had two possible discrete values (−1, 1), and the values were later substituted with two different normal distributions in the data sampling process (e.g., when a value −1 is sampled for a gene, a value is randomly sampled from the corresponding normal distribution instead). The number of different edge connections between two Bayesian networks B1 and B2 of two conditions was randomly determined to have a value higher than v (50%) for a differential gene set, and it was randomly determined to a value lower than v/2 (25%) for a non-differential gene set. As change in dependency (edge discrepancy) does not necessarily mean differential expressions, interaction-focused methods can be preferred in this scenario. Total 10,000 genes are generated, and the rest of 10,000-100r genes were randomly generated by repeating the same process of generating expressions for non-differential gene sets. For one synthetic data set, 50 differential gene sets and 50 non-differential gene sets were prepared, where each gene set has v genes. Gene set sizes of v=10, 20, and 30 were considered, and two different normal distributions for gene expressions have the same variance of 1 but different mean values of 1 and 3.

For each scenario, the simulation was repeated 100 times for each of GSEA, GSCA, and EDDY, and their average false/true positive rates were evaluated by varying the statistical significance p-value threshold from 0 to 1 by 0.01. For GSCA, Pearson correlation coefficient was used as a correlation measure. For EDDY, λ=1, M=1,000 and 5,000 dependency network structures of consideration, and K=3 were used. As EDDY relies on the Bayesian network model with discrete random variables, the expression levels of each gene were standardized and quantized to three discrete values of (−1, 0, 1) using one standard deviation as a threshold. For all three methods, the same 1,000 permutations were used to evaluate p-values.

Moreover, in this simulated experiment, a comparison of receiver operated characteristics (ROC) of EDDY, GSCA, and GSEA in identifying differential gene sets was calculated. ROC curves were calculated by plotting the value of a variable versus its relative frequency in two populations (i.e., false positive rate and true positive rate). The area under the ROC curve is a measure of the probability that the tested method (i.e., EDDY, GSCA, or GSEA) correctly identified differential gene sets in the simulation experiments. See, e.g., Hanley et al., Radiology 143: 29-36 (1982).

### Results

FIG. 16 illustrates the average receiver operating characteristics (ROC) of GSCA, GSEA, and EDDY from the two scenarios of simulation experiments, and Table 2 lists the area under curve values of the corresponding ROC curves in FIG. 16. From the results of the DEG-focused simulation experiments (FIGS. 16A-16C), GSCA and GSEA generally show better performance compared to EDDY. Superior performance of GSEA compared to EDDY in this scenario was expected, as no interaction change was made between two conditions while differential gene sets were prepared to have many differentially expressed genes between conditions. GSCA also showed comparable performance with GSEA, and this is because GSCA relies on measuring linear correlation differences between genes.

TABLE 2
The AUC values of GSCA, GSEA, and EDDY in identifying
differential gene sets from the simulation experiments.

| | Scenario I | | | Scenario II | | |
|---|---|---|---|---|---|---|
| Method | v = 10 | v = 20 | v = 30 | v = 10 | v = 20 | v = 30 |
| GSCA | 0.8103 | 0.8942 | 0.9355 | 0.5774 | 0.5822 | 0.5695 |
| GSEA | 0.6787 | 0.7781 | 0.8380 | 0.4911 | 0.5574 | 0.6075 |
| EDDY (i) | 0.6013 | 0.5630 | 0.5403 | 0.7440 | 0.6768 | 0.6704 |
| EDDY (ii) | 0.6159 | 0.5877 | 0.5770 | 0.8287 | 0.7580 | 0.7064 |

EDDY (i) indicates the case of M = 1,000 and EDDY (ii) indicates the case of M = 5,000

For example, GSCA can be applied to test the differentiality of a gene set between two conditions, where the gene set has only two genes V1 and V2 such that V1 is not a DEG, but V2 is a DEG. Then V1 would have the same probability distribution Pr₁ in both conditions while V2 has Pr₂ in one condition but Pr′₂ in another. With correlation p1 between Pr₁ and Pr₂ from one condition and p2 between Pr₁ and Pr′₂ from another, the absolute of Δp=p1−p2 defines the differentiality of this gene set. When the statistical significance is measured through the permutation test, V1 keeps the same Pr₁ in both randomly permuted conditions, while V2 has a mixture of Pr₂ and Pr′₂ in each randomly permuted condition. This makes V2 have similar bimodal distributions with high variance in both permuted conditions, and this phenomenon can lead to smaller correlation in each condition as well as smaller correlation changes. For this reason, there can be a significant chance of getting low p-values from GSCA when gene sets have many DEGs. On the contrary, V2 will also keep the same probability distribution Pr₂ in both randomly permuted conditions if V2 is not a DEG. As V1 and V2 keep their original probability distributions even after random permutations, Δp will be similar to that of randomly permuted cases, which leads to high p-values. This characteristic makes GSCA show comparable results with GSEA in DEG-focused simulation experiments.

From the results of the interaction-focused simulation experiments (FIG. 16D-16F), EDDY generally shows superior performance compared to GSEA and GSCA. EDDY provides superior results and analysis because the data was generated from models assuming conditional dependencies in gene expressions rather than simple linear correlations, which is also assumed by the Bayesian network model used by some embodiments of the EDDY system and method. The performance of EDDY declines with increasingly sized gene sets, but it can be improved with more computations (by using a larger M as shown in FIG. 16D-16F). In addition, in corroboration or previously described data, EDDY provided significantly reduced false positive rates compared to GSEA and GSCA. Besides the two simulation scenarios covered in this study, there can be various different simulation configurations depending on the methods to generate synthetic data sets and the definition of differential gene sets. From the results, EDDY showed better performance compared to GSEA and GSCA when gene interactions are defined in the sense of probabilistic dependencies rather than linear correlations.

In some particular embodiments, a method, EDDY, is provided as a statistical test method for a given set of discrete random variables to evaluate the differentiality of variable dependencies between two conditions and the associated statistical significance. Unlike previous gene set test methods that evaluate only differential expression, EDDY evaluates the discrepancy between conditions by considering the probability distribution of dependency networks. Even though there have been methods to identify differential interactions or condition-specific sub-networks, EDDY has a unique functionality of testing gene sets for dependency differentiality while those conventional methods lack the functionality of testing gene sets. The method provided has been evaluated through simulation experiments, which have demonstrated that EDDY provides well-correlated results with the true discrepancy behind the synthetic data sets and returns low numbers of false positives. EDDY was also applied to TOGA GBM gene expression data to identify gene sets that show statistically distinct genetic relationships among the four subtypes of GBM, and the EDDY results was compared with the result of GSEA. It was shown that EDDY can identify largely different gene compared to those identified by GSEA, while providing meaningful outcomes that are often consistent with previously reported findings, in addition to potentially novel findings regarding gene set relationships and interactions. EDDY was also compared to GSCA, which is a gene set test method that evaluates differential interactions within a gene set using pairwise correlation measures. The comparison of the two methods showed that EDDY is more reliable in identifying gene sets with differential interactions than GSCA, as a result of GSCA being biased with the size of gene sets, while EDDY does not display such a behavior.

As previously mentioned, in some embodiments of the invention, the method may comprise the use of a computing device to implement the EDDY application. In some embodiments, the computing device may include at least one processor in operative communication with a memory. For example, the computing device may be a personal computer, super computer, workstation, server, or mobile device, while the processor may be a hardware device that processes software, other machine-readable instructions, retrieved data, and/or received data. In addition, the memory may store software or other machine-readable instructions and data. The memory may also include volatile and/or non-volatile memory. The memory may include a database to store data related to parameters for various components of the method or any other data. The computing device may further include various hardware and accompanying software components.

In addition, the computing device may also include a communication system to communicate with one or more computing devices and systems over a communication network via wireline and/or wireless communications, such as through the Internet, an intranet, and Ethernet network, a wireline network, a wireless network. The computing device may further include a display for viewing data or one or more user interfaces, such as a computer monitor, and an input device, such as a keyboard or a pointing device (e.g., a mouse, trackball, pen, touch pad, or other device) for entering data and navigating through data, including images, documents, structured data, unstructured data, HTML pages, other web pages, and other data.

The computing device may include a database and/or is configured to access the database. The database may be a general repository of data including, but not limited to expression data, algorithms, or any other form of data / information. The database may include memory and one or more processors or processing systems to receive, process, query and transmit communications and store and retrieve such data. In another aspect, the database may be a database server.

According to one aspect, the computing device includes a computer readable medium (“CRM”), which may include computer storage media, communication media, and/or any another available media that can be accessed by the processor. For example, CRM may include non-transient / non-transitory computer storage media and communication media. By way of example and not limitation, computer storage media includes memory, volatile media, nonvolatile media, removable media, and/or non-removable media implemented in a method or technology for storage of information, such as machine/computer readable/executable instructions, data structures, program modules, or other data. Communication media includes machine/computer readable/executable instructions, data structures, program modules, or other data and includes an information delivery media or system. Generally, program modules include routines, programs, instructions, objects, components, data structures, etc., that perform particular tasks or implement particular abstract data types. By way of example and not limitation, the CRM may store executable instructions to execute one or more of the algorithms discussed above.

Some embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object.

In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

The invention can also be embodied as computer readable code on a computer readable medium. The computer readable medium may be any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium can also be distributed over a network coupled computer systems so that the computer readable code may be stored and executed in a distributed fashion. Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way. It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto.

Each patent and publication cited herein is incorporated by reference in its entirety, as if each such patent or publication were individually incorporated by reference herein. Various features and advantages of the invention are set forth in the following claims.

What is claimed is:

1. A computer implemented method of statistical testing for identifying or evaluating relationships between a plurality of genes, the method comprising:
receiving a target gene set containing a plurality of genes across a plurality of conditions;
evaluating each gene as a discrete random variable;
identifying a plurality of likely dependency network structures for the plurality of genes for each condition;
computing a probability distribution of the likely dependency network structures for each condition;
computing overall differential dependency relationships between genes in a target gene set across the plurality of conditions by calculating a difference between each probability distribution of likely dependency network structures among the plurality of conditions; and
identifying a plurality of biological functions and pathways that show genetic relationships across the plurality of conditions using the overall differential dependency relationships.

2. The method according to claim 1, wherein computing the probability distribution of the likely dependency network structures further comprises computing a posterior probability for each of the dependency network structures.

3. The method according to claim 2, wherein computing the probability distribution of the likely dependency network structures further comprises computing
$$Pr ( {g}_{i} \vert {D}_{C} ) = \frac{Pr ( {D}_{C} \vert {g}_{i} )}{{\sum }_{k = 1}^{N} Pr ( {D}_{C} \vert {g}_{k} )}$$
wherein Pr(D_{C}|gᵢ) is a likelihood, g is a dependency network, i is greater than or equal to 1, D_{C} is an observed condition.

4. The method according to claim 2, wherein computing the posterior probability for each of the likely dependency network structures further comprises using a Bayesian Dirichlet equivalence uniform (BDeu) scoring method.

5. The method according to claim 1, wherein computing a probability distribution of the likely dependency network structures comprises computing:
Prₚᵣₒₚₒₛₑ(i; j|D_{C})=(1−pᵢⱼ)^{λ},
for a probable dependency structure, gₖ, that is proposed for D_{C}, wherein:
λ≧1;
eᵢⱼ and eⱼᵢ are edges between variables Vᵢ and Vⱼ;
a direction of at least one of eᵢⱼ and eⱼᵢ is randomly chosen with a probability of 0.5 when the random choice complies with an acyclic property of a directed acrylic graph (DAG) for gₖ;
each of a dependency between Vᵢ and Vⱼ is independently evaluated; and
an χ2-test is applied to test the independency between each pair of Vᵢ and Vⱼ to obtain a p-value wherein (pᵢⱼ) (=pⱼᵢ).

6. The method according to claim 1, wherein computing the overall differential dependency relationships between genes in a target gene set across the plurality of conditions further comprises:
computing a divergence between conditions among the plurality of conditions; and
computing a statistical significance of a condition among the plurality of conditions.

7. The method according to claim 6, wherein computing the divergence between conditions further comprises measuring the divergence using a Jensen-Shannon (JS) divergence.

8. The method according to claim 6, wherein computing the statistical significance of a condition further comprises computing the statistical significance with a permutation approach.

9. A system comprising: a processor; and a non-transitory computer-readable storage medium storing instructions which, when executed on the processor, perform a method comprising:
receiving a target gene set containing a plurality of genes across a plurality of conditions;
evaluating each gene as a discrete random variable;
identifying a plurality of likely dependency network structures for the plurality of genes for each condition;
computing a probability distribution of the likely dependency network structures for each condition;
computing overall differential dependency relationships between genes in a target gene set across the plurality of conditions by calculating a difference between each probability distribution of the likely dependency network structures among the plurality of conditions; and
identifying a plurality of biological functions and pathways that show genetic relationships across the conditions using the overall differential dependency relationships.

10. A method of statistical testing for identifying or evaluating relationships between a plurality of genes, the method comprising:
obtaining a target gene set containing a plurality of genes across a plurality of conditions;
evaluating each gene as a discrete random variable;
identifying a plurality of likely dependency network structures for the plurality of genes for each condition;
determining a probability distribution of the likely dependency network structures for each condition;
determining an overall differential dependency relationships between genes in a target gene set across the plurality of conditions by calculating a difference between each probability distribution of the likely dependency network structures among the plurality of conditions; and
identifying a plurality of biological functions and pathways that show genetic relationships across the plurality of conditions using the overall differential dependency relationships.

11. The method according to claim 10, wherein determining the probability distribution of the likely dependency network structures further comprises computing a posterior probability for each of the likely dependency network structures.

12. The method according to claim 11, wherein determining the probability distribution of the likely dependency network structures further comprises computing
$$Pr ( {g}_{i} \vert {D}_{C} ) = \frac{Pr ( {D}_{C} \vert {g}_{i} )}{{\sum }_{k = 1}^{N} Pr ( {D}_{C} \vert {g}_{k} )}$$
wherein Pr(D_{C}|gᵢ) is a likelihood, g is a dependency network, i is greater than or equal to 1, D_{C} is an observed condition.

13. The method according to claim 11, wherein determining the posterior probability for each of the likely dependency network structures further comprises using a Bayesian Dirichlet equivalence uniform (BDeu) scoring method.

14. The method according to claim 10, wherein determining a probability distribution of the likely dependency network structures comprises computing:
Prₚᵣₒₚₒₛₑ(i; j|D_{C})=(1−pᵢⱼ)^{λ},
for a probable dependency structure, gₖ, that is proposed for D_{C}, wherein:
λ≧1;
eᵢⱼ and eⱼᵢ are edges between variables Vᵢ and Vⱼ;
a direction of at least one of eᵢⱼ and eⱼᵢ is randomly chosen with a probability of 0.5 when the random choice complies with an acyclic property of a directed acrylic graph (DAG) for gₖ;
each of a dependency between Vᵢ and Vⱼ is independently evaluated; and
an χ2-test is applied to test the independency between each pair of Vᵢ and Vⱼ to obtain a p-value wherein (pᵢⱼ) (=pⱼᵢ).
